(19) United States
(12) Patent Application Publication
(10) Pub. No.: US 2013/0080140 A1
(43) Pub. Date: Mar. 28, 2013

(54) USING A REQUIREMENTS FRAMEWORK

(71) Applicants: Matthew Brian BEHR, Brooklyn, NY (US); Pieter J. MOSTERMAN, Framingham, MA (US)

(72) Inventors: Matthew Brian BEHR, Brooklyn, NY (US); Pieter J. MOSTERMAN, Framingham, MA (US)

(73) Assignee: THE MATHWORKS, INC., Natick, MA (US)

(21) Appl. No.: 13/242,611

(22) Filed: Sep. 23, 2011

(51) Int. Cl. G06F 17/50

(52) U.S. Cl. 703/21

(57) ABSTRACT

A computing device may be configured to receive a design. The computing device may further receive a requirement object that represents a requirement for the design. The requirement object may include a first functionality and a second functionality. The computing device may interact with the design using the requirement object. When interacting with the design, the computing device may invoke the first functionality to determine whether the design satisfies the requirement and invoke the second functionality to provide a result of invoking the first functionality.

### BRIEF DESCRIPTION OF THE DRAWINGS

The accompanying drawings, which are incorporated in and constitute a part of this specification, illustrate one or more implementations described herein and, together with the description, explain these implementations. In the drawings:

FIG. 1 is a diagram of an example computing device that may implement one or more embodiments of the invention;

FIG. 2 is a diagram illustrating an example framework;

FIG. 3 is a diagram illustrating an example requirements framework component of the framework of FIG. 2;

FIG. 4 is a diagram illustrating an example requirement structure;

FIG. 5 is a diagram illustrating an example object-oriented architecture for requirements;

FIGS. 6A-6D illustrate example relationships between requirements and components of a design;

FIG. 7 is a flowchart of an example process for using a requirements framework to evaluate, modify, or create a design;

FIG. 8 is a flowchart of an example process for evaluating a design;

FIG. 9 is an example interface used for evaluating the design;

FIG. 10 is a flowchart of an example process for creating a design;

FIG. 11 is an example interface used for creating the design;

FIGS. 12A-12D are flowcharts of an example process for verifying whether a design satisfies a requirement; and

FIG. 13 is a diagram of an example distributed network in which systems and/or methods described herein may be implemented.

### DETAILED DESCRIPTION

The following detailed description refers to the accompanying drawings. The same reference numbers in different drawings may identify the same or similar elements.

A design may include a representation of a system and/or software. A type of a design may refer to a purpose of a design and/or to a type of a representation of the design. In one example, when referring to the purpose of the design, the design may include one or more of: a conceptual design, a high-level design, a detailed design, a functional design, an architectural design, a structural design, or a behavioral design.

In another example, when referring to the type of the representation of the design, the design may include one or more of: a graphical model, a textual model, a time-based modeling diagram, a class diagram, an object diagram, a state transition diagram, a unified modeling language (UML) diagram, a system modeling language (SysML) diagram, an architecture description language (ADL) diagram, hardware code, software code, differential equations, difference equations, algebraic equations, assignments, a dynamically typed language, an array-based language, an action language, a collection of data, etc. In yet another example, a type of the design may be associated with a particular modeling tool or a particular source code language used to create the design.

Different types of designs may represent different portions/aspects of systems. For example, a quality design may include elements related to reliability of a design. An architectural design may include elements related to an organization and/or a structure of a system (e.g., a computer architecture, a software architecture, a system architecture, etc.).

A computer device may execute, implement, and/or utilize a design to simulate a system and/or software represented by the design. A realization of a design may refer to a result of an execution of a design. An implementation of a design may refer to a design that is functioning as a system during an execution.

A design may include a plurality of execution domains. Each one of the execution domains may include one or more of: a continuous time domain, a discrete time domain, a discrete event-based domain, a control flow-based domain, or a data flow-based domain.

A design may include one or more components. A component may represent a portion of the design. An element or elements of a design may refer to a component or components of the design, respectively.

A requirement may represent/specify, for example, an attribute, a capability, a characteristic, and/or a quality that a design is required to possess. A requirement element may represent a requirement. A requirement element may include a requirement object and/or one or more other types of data structures. Any reference below to a requirement, to a requirement object, and/or to a requirement element may be applicable to a collection of requirements, to a collection of requirement objects associated with the requirements, and/or to a collection of requirement elements associated with the requirements.

A requirement element may include one or more functionalities and one or more properties, as described further below. Invoking one of the functionalities may include a method call, a remote method invocation, a procedure call, a remote procedure call, or a function call.

An entity may require a design to comply with one or more applicable requirements before the design is utilized for one or more functions. The entity may include a person (e.g., a user, a developer, etc.), a device (e.g., a client, a server, etc.), an organization, etc. A device, associated with the entity, may use a requirement object corresponding to a requirement to determine whether a design satisfies the requirement.

An entity may organize one or more requirements into a collection of requirements. A collection of requirements may refer to a set of requirements, an array of requirements, a linked list of requirements, a dictionary of requirements, a vector of requirements, a matrix of requirements, and/or any other grouping of (e.g., a data structure that includes) one or more requirements. A collection of requirements may also refer to a collection of requirement elements associated with requirements and/or a collection of requirement objects associated with requirements. A collection of requirements may be heterogenous. For example, an array of requirements may include requirement objects of different types. An entity and/or a framework may organize the one or more requirements into a collection of requirements based on a use of the requirements, a type of the requirements, version(s) of the requirements, and/or based on one or more other factors. Requirements can be tested against any type of design (e.g., a dynamic model, a computational model, a behavioral design, an architectural design, etc.) to which the requirements in the collection are applicable and/or a type of system (e.g., manufacturing machinery, consumer electronics, automotive systems, aerospace systems, etc.) represented by the design. In one implementation, the requirements can further be tested against alternated forms and/or implementations of designs. For example, requirements can be tested against multiple, different, algorithmic forms of a design, including a graphical model and generated code. The other factors may include, for example, personal preferences of the user.

### Overview

Embodiments, described herein, may use a requirements framework to determine whether a design satisfies one or more requirements. For example, the requirements framework may receive a design and a requirement element that represents a requirement. The requirements framework may modify the requirement element in order to use the requirement element to determine whether the received design satisfies the requirement. Thereafter, the requirements framework may instantiate the requirement element, and may invoke a verifying functionality of the requirement element. The verifying functionality may interact with the design to determine whether the design satisfies the requirement. The verifying functionality may provide an output (e.g., return a result) that indicates whether the design satisfies the requirement. In one implementation, the requirements framework may invoke a reporting functionality of the requirement element that creates a report based on the output. The report may specify whether the design and/or one or more particular components of the design satisfy the requirement. In another implementation, the requirements framework may invoke an annotating functionality that annotates the design and/or one or more relevant components of the design. The annotation may indicate whether the design and/or the one or more relevant components satisfy the requirement.

Additionally, or alternatively, an embodiment, as described herein, may use a requirements framework to create a new design and/or to modify an existing design. In one example, the requirements framework may receive requirement elements that represent different requirements for different components of the design. The requirements framework may invoke crawling functionalities of the requirement elements. The crawling functionalities may identify components that satisfy the requirements. The requirements framework may create a new design based on the identified components. In another example, the requirements framework may receive an existing design and a requirement element that represents a requirement. The requirements framework may modify the existing design so that the design satisfies the requirement. Modifying the design may include adding a new component to the design, replacing an old component of the design with a new component, and/or modifying the old component.

### Example Components of a Device

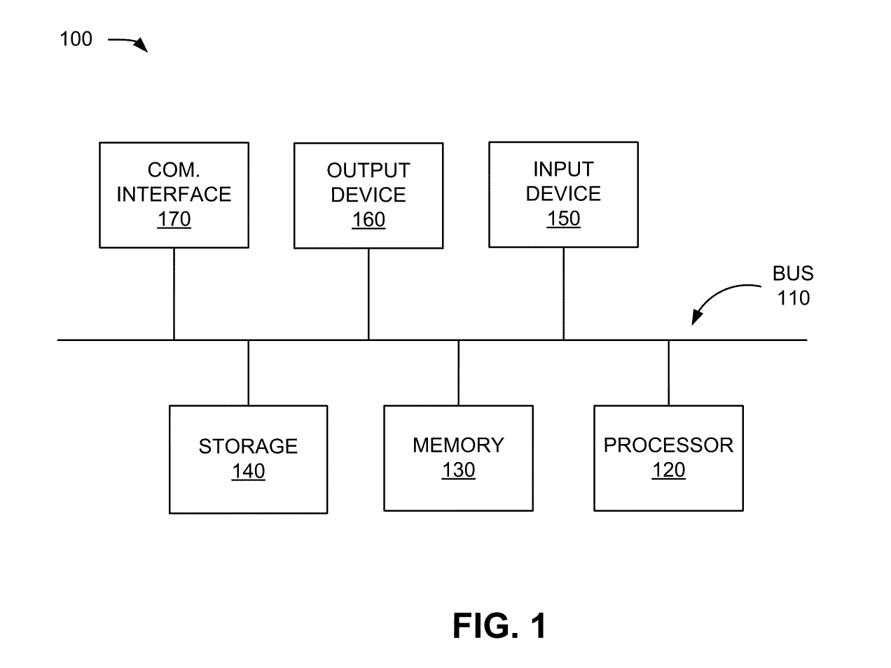

FIG. 1 is a diagram of example components of a device 100 that may implement embodiments described below. Device 100 may include a computational device. For example, device 100 may include a server, a workstation, a mainframe, a desktop computer, a laptop computer, a smart phone, a tablet computer, and/or some other type of computational device.

Referring to FIG. 1, device 100 may include, among other things, a bus 110, a processor 120, a memory 130, a storage 140, an input device 150, an output device 160, and/or a communication interface 170. In other implementations, device 100 may include fewer components, additional components, different components, and/or a different arrangement of components than those depicted in FIG. 1.

Bus 110 may permit communication between components of device 100. Bus 110 may include a system bus, an address bus, a data bus, and/or a control bus. Bus 110 may also include bus drivers, bus arbiters, bus interfaces, and/or clocks.

Processor 120 may interpret and/or execute instructions. For example, processor 120 may include one or more general-purpose processors, microprocessors, data processors, graphical processing units (GPUs), co-processors, network processors, application specific integrated circuits (ASICs), application specific instruction-set processors (ASIPs), system-on-chip (SOC), controllers, programmable logic devices (PLDs), chipsets, and/or field programmable gate arrays (FPGAs).

Memory 130 may be a non-transitory tangible computer-readable storage medium that may store data and/or instructions related to an operation and use of device 100. For example, memory 130 may store data and/or instructions that may implement one or more embodiments described herein. Memory 130 may include, for example, a random access memory (RAM), a dynamic random access memory (DRAM), a static random access memory (SRAM), a synchronous dynamic random access memory (SDRAM), a ferroelectric random access memory (FRAM), a read only memory (ROM), a programmable read only memory (PROM), an erasable programmable read only memory (EPROM), an electrically erasable programmable read only memory (EEPROM), and/or a flash memory.

Storage 140 may include a non-transitory tangible computer-readable storage medium that may store data and/or software related to operation and use of device 100. For example, storage 140 may include a hard disk (e.g., a magnetic disk, an optical disk, a magneto-optic disk, a solid state disk), a floppy disk, a cartridge, a magnetic tape, and/or other types of non-transitory tangible computer-readable storage mediums. Moreover, storage 140 may include a drive that may hold the medium. For example, storage 140 may include a compact disc and a compact disk drive that may be used to read/write the compact disc.

It should be noted that a computer-readable medium is intended to be broadly interpreted to include a memory, storage, or other computer-readable mediums. A computer-readable medium may be tangible and may be implemented in a single device, in multiple devices, in a centralized manner, or in a distributed manner. A computer-readable medium may correspond to, for example, a physical device or a logical device that may store computer-executable instructions for performing one or more activities on a computing device and/or that may store data that may be manipulated by a computing device. A logical device may be a device that may include storage within a single physical device or storage that may be spread across multiple physical devices. Examples of logical devices may include, but are not limited to, virtual drives and virtual memory. The computer-readable medium may store data and/or instructions that may implement one or more embodiments of the invention.

Memory 130 and/or storage 140 may also include a storage device external to and/or removable from device 100, such as a Universal Serial Bus (USB) memory stick, a hard disk, network storage, or other storage devices.

Input device 150 may permit information to be input into device 100. Input device 150 may include, for example, a keyboard, a keypad, a mouse, a display (e.g., a touch screen), a button, a switch, a microphone, voice recognition logic, a camera, a gyroscope, an accelerometer, a global positioning system (GPS), an input port, and/or some other type of input device. Output device 160 may permit information to be output from device 100. Output device 160 may include, for example, a display, a speaker, one or more light emitting diodes (LEDs), an output port, and/or some other output device.

Communication interface 170 may permit device 100 to communicate with other devices, networks (e.g., a local area network, wide area network, the Internet, etc.), and/or systems. Communication interface 170 may include a transceiver-like component that enables communication with the other devices. Examples of communication interface 170 may include a built-in network adapter, network interface card (NIC), Personal Computer Memory Card International Association (PCMCIA) network card, card bus network adapter, wireless network adapter, Universal Serial Bus (USB) network adapter, modem or other device suitable for interfacing the device 100 to a network.

As will be described in detail below, device 100 may perform certain acts relating to embodiments described herein. Device 100 may perform these acts in response to processor 120 executing software instructions contained in a computer-readable medium, such as memory 130 and/or storage 140. The software instructions may be read into memory 130 from another computer-readable medium, such as storage 140, or from another device via communication interface 170. The software instructions contained in memory 130 may cause processor 120 to perform acts described herein. Alternatively, hardwired circuitry may be used in place of or in combination with software instructions to implement acts described herein. Thus, embodiments described herein are not limited to any specific combination of hardware circuitry and software.

### Example Requirements Framework

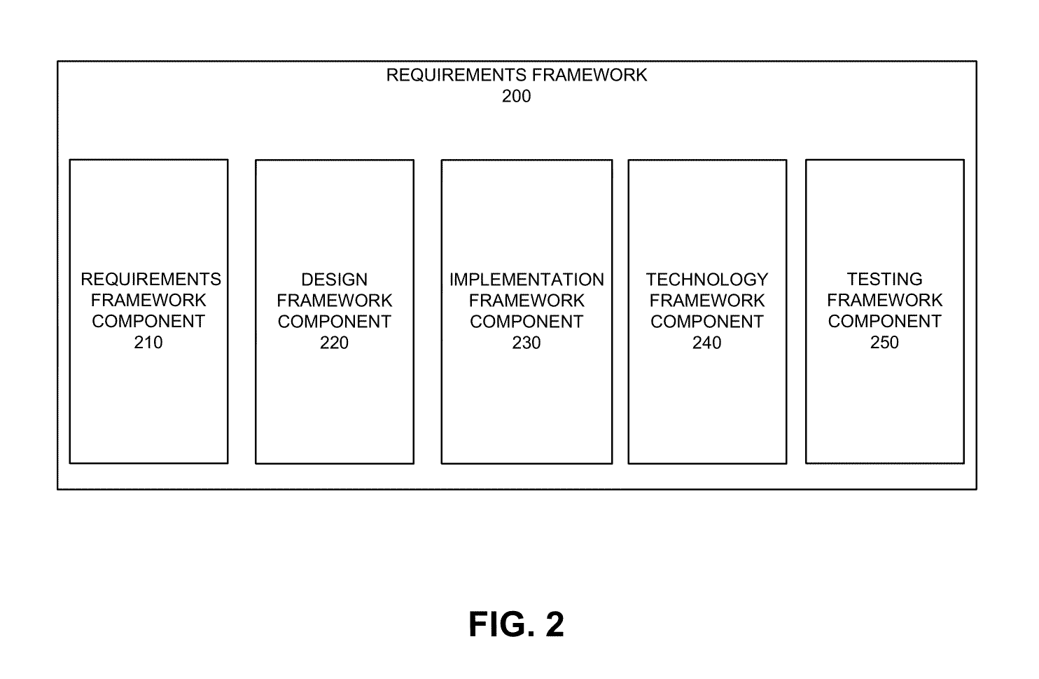

FIG. 2 is a diagram illustrating an example requirements framework 200. In one implementation, storage 140 may store requirements framework 200.

Requirements framework 200 may receive a requirement element and a design. Requirements framework 200 and/or the requirements element may determine whether the requirement element complies with requirement element criteria. The requirement element criteria may specify which properties and/or functionalities the requirement element must include. Requirements framework 200 and/or the requirements element use invocation criteria. The invocation criteria may specify which applicability criteria, of the requirement element, should be used to assess whether the requirement element is applicable to the design. Requirements framework 200 and/or the requirement element may use the applicability criteria. The applicability criteria may specify whether the requirement element is applicable to the design. Requirements framework 200 and/or the requirement element may further determine whether the design satisfies a requirement associated with the requirement element. In another implementation, requirements framework 200 may receive the requirement element as part of a collection of requirement elements (e.g., an array of requirement elements). The aforementioned process may occur in relation to each one of the other requirement elements of the collection of requirement elements.

Requirements framework 200 may include a requirements framework component 210, a design framework component 220, an implementation framework component 230, a technology framework component 240, and a testing framework component 250. In practice, requirements framework 200 may include additional components, fewer components, and/or different components than those shown in FIG. 2. For example, framework 200 may only include requirements framework component 210 and design framework component 220.

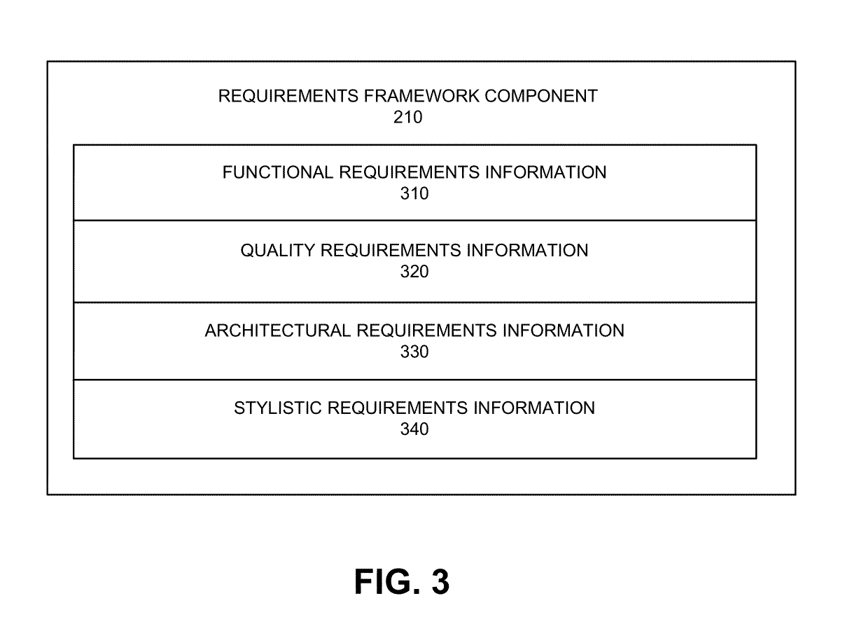

Requirements framework component 210 may receive and/or store requirements information associated with requirement objects. The requirements information may include, for example, requirement element criteria, invocation criteria, and applicability criteria. The requirement element criteria may specify one or more functionalities (e.g., methods) and/or one or more properties that a requirement object must include. The invocation criteria may specify which applicability criteria of the requirements framework and/or of the requirement element are active. The applicability criteria may specify when a requirement object is applicable to a particular design. Requirements framework component 210 may apply different requirement element criteria, invocation criteria, and/or applicability criteria based on a particular type of a requirement corresponding to the requirement object, as described further below in reference to FIG. 3.

In another implementation, requirements framework component 210 may store information about optional characteristics of requirement objects. For example, the information about optional characteristics may specify one or more optional functionalities and/or one or more optional properties that a requirement object is allowed to include, but is not required to include, in order to comply with requirement element criteria. The one or more optional functionalities and/or the one or more optional properties may comply with criteria of requirements framework 200. The information about optional characteristics may specify the criteria for the optional functionalities and/or the optional characteristics. Requirements framework 200 may invoke the one or more optional functionalities and/or the one or more optional properties.

In yet another implementation, requirement objects may include one or more functionalities and/or one or more properties with access restrictions (e.g., public, private, protected). For example, a functionality with a private access restriction may not be accessible (e.g., invoked) by the requirements framework or other requirement objects.

Design framework component 220 may receive and/or store design information associated with designs. The design information may include design criteria. The design criteria may specify characteristics of a design. The design criteria may vary based on a type of the design (e.g., a functional design, an architectural design). In one example, the design information may include a list of allowed programming languages. When a design includes software code, the design criteria may, for example, require the software code to be in one of the programming languages included in the list of allowed programming languages.

In another example, the design information may include a list of one or more allowed graphical model elements (e.g., a product block, a sum block, a time delay block, a sampled data signal, a continuous-time integrator block, a bus creator block, a bus signal, a subsystem block, a state transition chart block, a function-call signal, a substate block, a control junction block, a rigid body block, a rotational joint block, a prismatic joint block, a local solver block, an electrical resistor block, an electrical capacitor block, an electrical transistor block, an electrical ground block, an annotation element, etc.). When a design includes a graphical model, the design criteria may, for example, require the graphical model to only use graphical model elements in the list of allowed graphical model elements. The design criteria may also vary based on one or more type(s) of requirements that are applicable to a particular design.

Requirements framework 200 and/or another entity may associate requirement object(s) with element(s) of a design. For example, a requirement object may include an identifier that corresponds to an annotation or other unique identifier of element(s) of a design. In some examples, when a requirement object is associated with an element of a graphical stage of a design, the requirement object may be reused for an element of code, which represents the design and is generated based on the graphical stage of the design. Requirements framework 200 may query the design to return the annotations of some or all elements of the design. Requirements framework 200 may then associate the requirement object with one or more of the elements with annotations that corresponds to the identifier. Additionally, or alternatively, requirements framework 200 may parse at least part of the design to determine which requirement object to associate with which element of the design.

An element of a design may include one or more of a unit (e.g., a block, a state, a component, an object, a class, a system, a supersystem, or a subsystem), a relation (e.g., a line, a signal, a bus, a transition, a life line, a method call, an association, an aggregation, an inheritance, or a channel), a parameter, a variable, a configuration (e.g., a hardware target, an optimization, a diagnostic, or a solver), a hierarchical layer, a workspace, etc. Requirements framework 200 and/or a requirement object may associate the requirement object with the element of the design based on one or more of an annotation, a name, a tag, a type, an identifier, a label, a checksum, a reference, a link, etc. of the requirement object and/or of the design element. The association may result in an active link (e.g., a hyperlink) from the element of the design to the requirement object and/or from the requirement object to the element of the design. Multiple requirement objects may be associated with one design element. Multiple design elements may be associated with one requirement object.

Requirements framework 200 and/or another entity may scope an association of a requirement object with a design element. For example, requirements framework 200 may store a requirement object in a workspace of a hierarchical layer of a design. An identifier of the requirement object may associate the requirement object with design elements, of the design, in the hierarchical layer. The same identifier, which is stored in a different workspace of a different hierarchical layer of the design, may associate a different requirement object with different design elements in the different hierarchical layer.

Additionally, or alternatively, requirements framework 200 and/or another entity may store a requirement object in a logical workspace. The requirement object may be accessed via a command line interface, a graphical model, and/or programmatically.

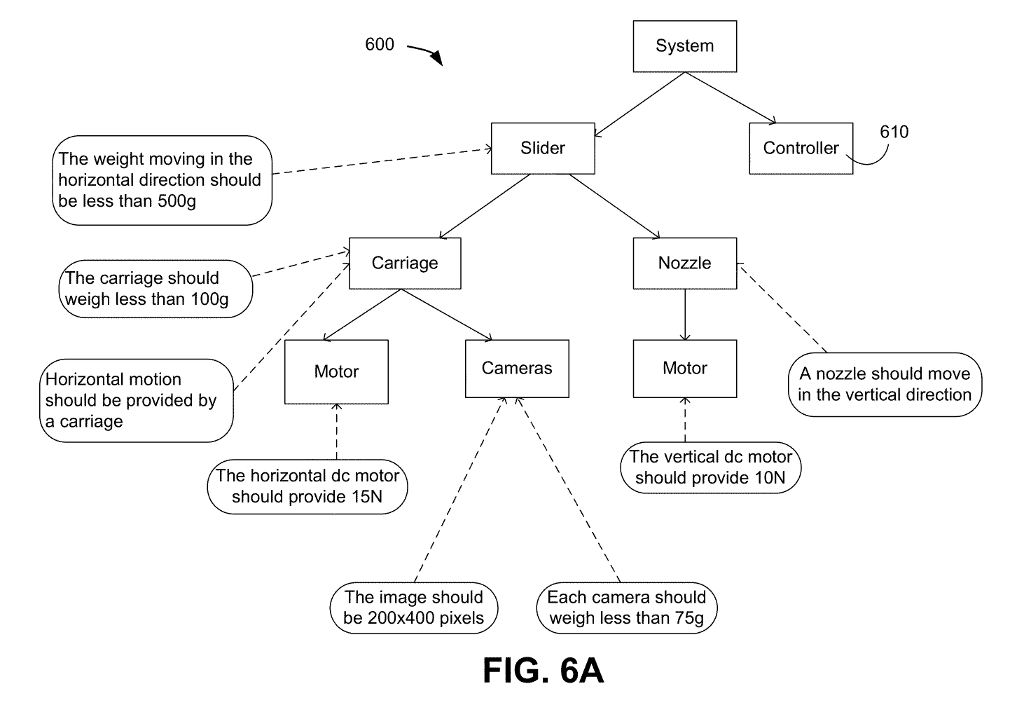

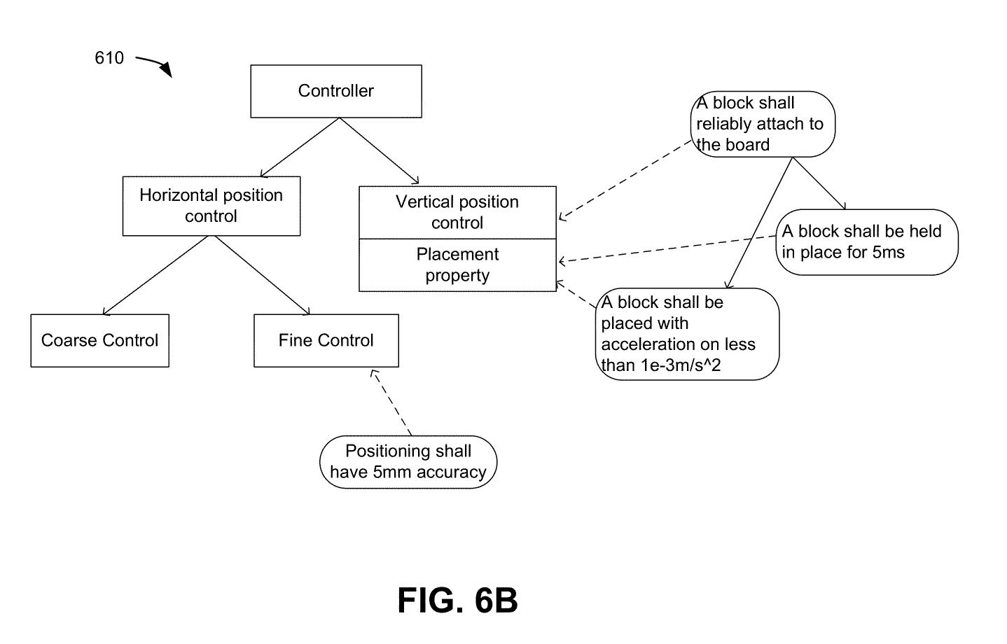

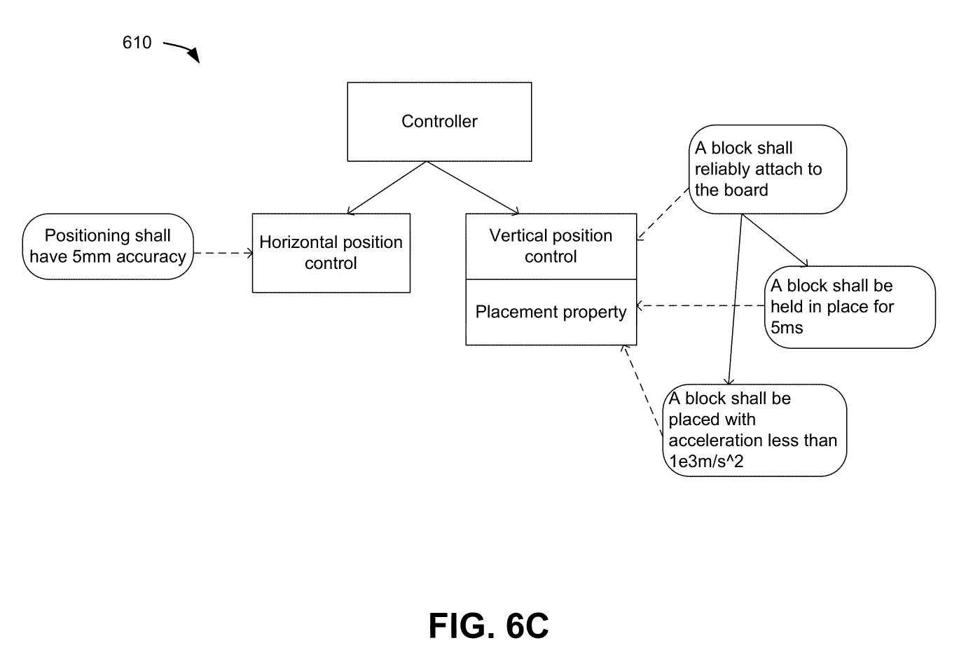

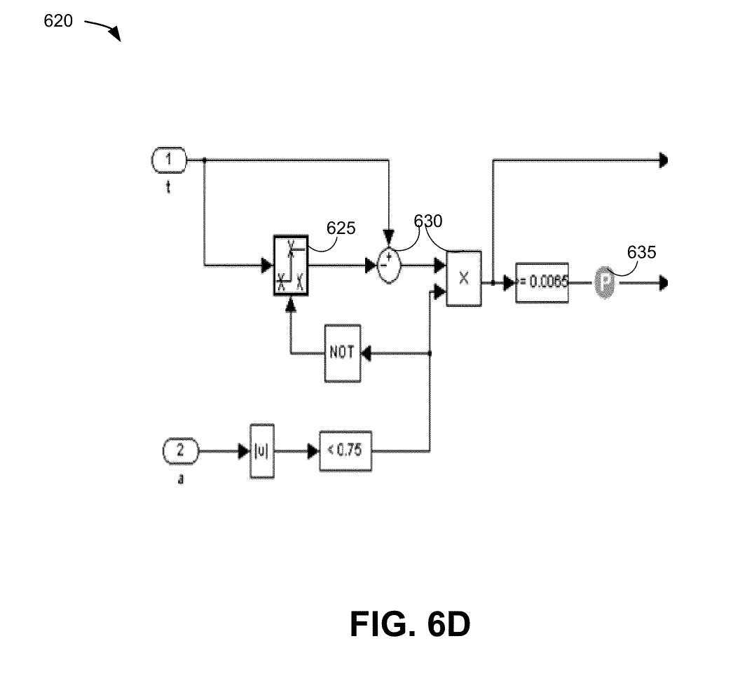

The design information may also include rules for modifying (e.g., simplifying) a design based on requirements that are applicable to the design. In one example, a rule may eliminate any explicit inclusion (e.g., representation) of an element that does not include any other elements and is not related to any one of the requirements applicable to the design. In another example, a rule may automatically replace any memory blocks in a design when the design criteria states that only unit delay blocks are to be used in the design. Similarly, a rule may replace integrator blocks with discrete transfer function blocks based on discretization criteria. Further examples are illustrated below in reference to FIGS. 6B and 6C.

Implementation framework component 230 may store implementation information associated with implementing designs. The implementation information may include implementation criteria (e.g., whether to use global variables, whether to use references such as pointers, whether to use recursion, etc.). Requirements framework 200 may execute/implement a design by using a particular technology (e.g., a personal computer, a microprocessor, an operating system, or middleware) specified by the implementation criteria. An implementation of the design may include code, such as programming code (e.g., C, C++, etc.) and/or hardware description language (HDL) code.

The same requirement objects may be reused to test different implementations of the same design, including, for example, a first implementation that includes code in a first programming language (e.g., C), a second implementation that includes code in a second programming language, a third implementation that includes code in a HDL, etc. Additionally, or alternatively, the same requirement objects may be reused with test data generated by using (e.g., executing) any one of the aforementioned implementations of the same design.

Technology framework component 240 may store technology information associated with implementations of designs. The technology information may include technology criteria. The technology criteria may specify a target technology to use to execute/implement a design, for example, during testing of the design (e.g., before determining whether the design satisfies a requirement) and/or an implementation of the design. For example, the technology criteria may specify a particular type of computing platform (e.g., a personal computer platform with a particular type of processor, a particular semiconductor technology such as complementary metal-oxide-semiconductor (CMOS), a particular compiler) for testing a particular type of design (e.g., a graphical model of an architectural design) and/or implementation associated with the design. Requirements framework 200 may use the particular type of computing platform to test the design and/or the implementation.

Testing framework component 250 may store testing information associated with testing whether design(s) and/or implementations of the design(s) satisfy requirements by using requirement objects, corresponding to the requirements, which are applicable to the design(s) and/or the implementation(s). The testing information may specify how to test whether a particular design and/or an implementation of the particular design satisfies the requirements. For example, the testing information may specify that when testing a particular (type of) design that includes a graphical model, requirements framework 200 is to compile the design, execute the design, and store an output of the execution in a particular storage.

Additionally, or alternatively, testing information may specify a data structure and/or identifiers for storing the output of the execution. Requirements framework 200 may create a data structure during testing of the design. The testing information may specify that a verifying functionality of a requirement object is to access the created data structure to determine whether the design satisfies a requirement associated with the requirement object. In another implementation, testing framework component 250 may also store applicability criteria and/or invocation criteria, described above with reference to requirements framework component 210.

Traceability may exist between designs, implementations of the designs, and/or sources of requirements (e.g., requirement elements). Requirements framework 200 may use the traceability to associate a requirement element with an element of an implementation based on an element of a design with which the requirement element is associated via the traceability. Requirements framework 200 may store, in the requirement element, information about the association of the element of the implementation with the requirement element. Thereafter, requirements framework 200 may determine the element of the implementation that is associated with the requirement element based on the stored information.

Requirements framework 200 and/or the requirement element may determine the association of a requirement element with an implementation element, based on properties and functionality of the requirement element, by using and by not using the traceability between design(s) and implementation(s) of the design(s). For example, requirements framework 200 may establish a first determination by using the traceability and a second determination by not using the traceability. Requirements framework 200 may assess the first determination and the second determination by, for example, determining whether consistency exists between the two determinations. Requirements framework 200 may determine that consistency exists between the two determinations when both of the two determinations associate the requirement element with the same implementation element.

### Example Requirements Framework Component

FIG. 3 is a diagram illustrating an example requirements framework component 210. As shown, requirements framework component 210 may include functional requirements information 310, quality requirements information 320, architectural requirements information 330, and stylistic requirements information 340. In practice, requirements framework component 210 may include additional information, fewer information, or different information than shown in FIG. 3.

Functional requirements information 310 may include criteria for requirement objects, corresponding to functional requirements, used to assess behavior of a system represented by a design. For example, requirements framework 200 may receive a requirement object used to determine that a camera of a system captures images with a particular resolution (e.g., 200×400 pixels). Requirements framework 200 may use functional requirements information 310 to determine whether the received requirement object complies with requirement element criteria for functional requirement objects. For example, a functional requirement element may be required to have a verify functionality that checks whether a design satisfies the requirement associated with the requirement element. As another example, a functional requirement may be required to have an error codes property that lists the error codes that invoking the verify functionality may return.

Quality requirements information 320 may include criteria for requirement objects, corresponding to quality requirements, used to assess characteristics of a system represented by a design. The quality requirements may include any requirement associated with the system, which are not functional requirements. For example, the quality requirements may include one or more of requirements related to dependability, availability, reliability, quality of service, maintainability, performance, etc. In one example, requirements framework 200 may receive a requirement object that corresponds to a quality requirement and that is used to determine that a camera of a system weighs less than a particular maximum amount (e.g., 75 grams). In another example, requirements framework 200 may receive a requirement object that corresponds to a quality requirement and that is used to determine that a frame delay jitter of a video stream of a camera is less than a particular value (e.g., 50 microseconds). Requirements framework 200 may use quality requirements information 320 to determine whether the received requirement object complies with requirement element criteria for quality requirement objects. As discussed below, requirements framework 200 may transform a functional requirement into a quality requirement and/or transform a quality requirement into a functional requirement (e.g., when the design is transformed).

Architectural requirements information 330 may include criteria for requirement objects, corresponding to architectural requirements, used to assess an architecture of a design. An architecture of a design may refer to, for example, elements included in the design, structure/organization of the elements, and/or interactions between the elements. For example, requirements framework 200 may receive a requirement object used to determine that a horizontal position control element of a design is dependent on (e.g., is part of) a controller element of the design. Requirements framework 200 may use architectural requirements information 330 to determine whether the received requirement object complies with requirement element criteria for architectural requirement objects.

Stylistic requirements information 340 may include criteria for requirement objects, corresponding to stylistic requirements, used to assess whether design standards (e.g., style guidelines) are met by a design and/or an implementation of a design. Design standards may include/refer to any preferences for presenting the design. Adherence to design standards by a design and or an implementation of a design, may not affect a result of an execution of the design. In one example, requirements framework 200 may receive a requirement object used to determine that a graphical model does not have crossing lines. In another example, requirements framework 200 may receive a requirement object used to determine that a software code of an implementation does not include an identifier, of a variable, that includes only a single character. Requirements framework 200 may use stylistic requirements information 340 to determine whether the received requirement object complies with requirement element criteria for stylistic requirement objects.

### Example Requirement Structure

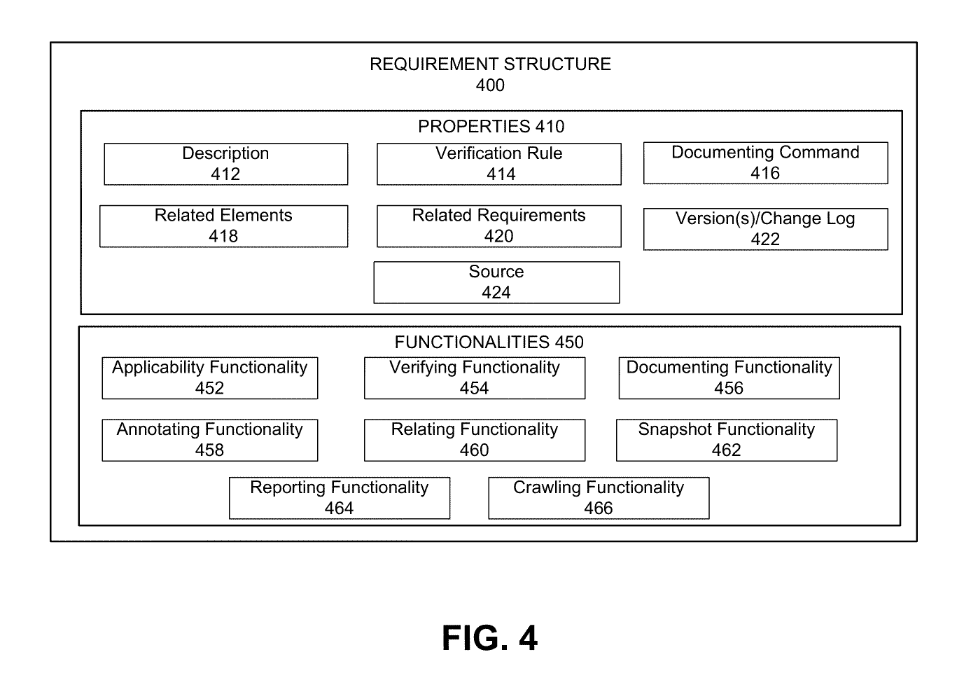

FIG. 4 is a diagram illustrating an example requirement structure 400 for a particular requirement object. As shown in FIG. 4, requirement structure 400 may include properties 410 and functionalities 450. A user may use object-oriented techniques to create each one of properties 410 and functionalities 450 based on one or more objects. A functionality may refer to a method, a procedure, a subroutine, an instruction, etc. The user may also set requirement element criteria that specify which properties 410 and which functionalities 450 the particular requirement object is to include, is preferred to include, and/or is allowed to include. The user may further set requirement element criteria that specify which ones of properties 410 and which ones of functionalities 450 are enabled/activated or disabled/inactivated.

As further shown in FIG. 4, properties 410 may include a description 412, a verification rule 414, a documenting command 416, related elements 418, related requirements 420, versions/change log 422, and a source 424. In practice, properties 410 may include additional properties, fewer properties, or different properties than shown in FIG. 4.

Description 412 may include a natural language description of a requirement corresponding to the requirement object. Description 412 may also include a description of when the requirement is applicable. Requirements framework 200 may parse the natural language description, of description 412, for keywords that correspond to one or more elements (e.g., variables, blocks, parameters, etc.) that are included in one or more designs. Requirements framework 200 may associated a requirement object to one or more elements of the one or more designs based on the parsing.

Verification rule 414 may specify a requirement (e.g., that a camera's weight be less than a certain number of grams). Additionally, or alternatively, verification rule 454 may store specifications, which define characteristics (e.g., of an element, a data set, connected elements, a configuration, etc.) necessary to satisfy the requirement.

Documenting command 416 may be used to create documentation for a requirement in a particular format defined, for example, by a user. In one implementation, the documentation may include properties and functionalities of the requirement and/or of one or more related requirements. In another implementation, the documentation may identify only a subset of all properties and functionalities of the requirement. For example, the documentation may only identify properties and/or functionalities that are related to the verification of the requirement.

Related elements 418 may specify one or more elements of a design (e.g., identification of particular block(s) of a graphical model), one or more elements of an implementation of the design, one or more elements of an architecture of the design, one or more elements of a technology of the design, and/or one or more portions of data (e.g., created by implementing/executing the design/implementation) that are related to a requirement. Related requirements 420 may store identifiers of other requirements/requirement objects that are related to the requirement.

Versions/change log 422 may store information about versions of functionalities included in a requirement object and/or a statement and/or an explanation regarding which changes were made. For example, an explanation may state/indicate that a version of a functionality was changed/updated because a new functionality was added to the requirement object corresponding to the requirement.

Additionally, or alternatively, versions/change log 422 may store information relating to version(s) of the requirement object over time. Versions/change log 422 may store the information as snapshots of the requirement object. A snapshot of the requirement object may specify which functionalities and/or properties are included in the requirement object and at which point in time these functionalities and/or properties were added. Additionally, or alternatively, a snapshot may include results of evaluating requirement functionalities.

Additionally, or alternatively, versions/change log 422 may store information that indicates that a particular version of the requirement object was approved by a particular entity, for example, when the particular version of the requirement object was used to test one or more particular designs.

Source 424 may identify an external source of a requirement object that and/or of a requirement corresponding to the requirement object. For example, source 424 may identify a particular collection of requirements, a particular database, a vendor, a model line, and/or a particular library that included the requirement object and/or a class from which the requirement object is instantiated. Additionally, or alternatively, source 424 may identify one or more external documents, such as a request for proposal (RFP), based on which the requirement and/or the requirement object was created.

One of properties 410 of the requirement object may reference a property of a different requirement object. When the referenced property, of the different requirement object, is modified, the one of properties 410 may automatically adjust to mirror the modified referenced property. Conversely, when the one of properties 410 is modified, the referenced property may also automatically adjust to mirror the modified one of properties 410. In another implementation, one or more of properties 410 may reference one or more different properties of one or more different requirement objects.

As further shown in FIG. 4, functionalities 450 may include an applicability functionality 452, a verifying functionality 454, a documenting functionality 456, an annotating functionality 458, a relating functionality 460, a snapshot functionality 462, a reporting functionality 464, and a crawling functionality 466. In practice, functionalities 450 may include additional functionalities, fewer functionalities, or different functionalities than shown in FIG. 4.

Applicability functionality 452 may determine whether a requirement is applicable to a design. For example, a requirement object may include applicability functionality 452 and an embodiment may determine whether a requirement, represented by the requirement object, is applicable to a particular design. Requirements framework 200 may utilize other functionalities of the requirement object, to test whether a particular design satisfies the requirement, when an output of applicability functionality 452 indicates that the requirement is applicable to the design. In one implementation, applicability functionality 452 may determine whether a requirement object is applicable to a design based on description 412, related elements 418, and/or other information of the requirement object and/or based on information associated with design elements of the design. As discussed above, the design information associated with the design elements may include a name, a type, an annotation, a tag, a link, etc.

In one example, description 412 may specify that a particular requirement is applicable to a camera component, when the camera component is used as part of a carriage component. Applicability functionality 452 may determine, based on description 412 and/or related elements 418, that a requirement is applicable to a design when the design includes particular design elements (e.g., a camera block) and/or particular design characteristics (e.g., the camera block depends on a carriage block). In another example, applicability functionality 452 may determine whether a particular requirement for continuous-time signals (e.g., that a data type of continuous time signals is double) is applicable to a design. Applicability functionality 452 may determine that the particular requirement is applicable when the design includes continuous-time signals. Requirements framework 200 may notify a user when applicability functionality 452 determines that a requirement is not applicable. Requirements framework 200 may, for example, notify the user by presenting a warning or an error in a dialog box or by making a statement in a report.

Verifying functionality 454 may determine whether a design satisfies a requirement, for example, based on verification rule 414. Documenting functionality 456 may use documenting command 416 to create documentation for a requirement.

Annotating functionality 458 may annotate the design, for example, based on an output of applicability functionality 452, an output of verifying functionality 454, and/or related elements 418. Annotating functionality 458 may annotate related elements 418 to indicate whether the design and/or related elements 418 have a requirement associated with them. Annotating functionality 458 may further annotate related elements 418 to indicate whether the design and/or related elements 418 satisfy the requirement. For example, annotating functionality 458 may annotate a block, of a design, that represents a camera to indicate that the camera satisfies (or does not satisfy) a requirement (e.g., to indicate that the camera weighs less than 75 grams).

Relating functionality 460 may provide identifiers of other requirements/requirement objects that are related to the requirement corresponding to the particular requirement object. Relating functionality 460 may retrieve the identifiers of the other requirements/requirement objects from related requirements 420. Requirements framework 200 may determine whether a design satisfies the other requirements whenever requirements framework 200 invokes verifying functionality 454.

Snapshot functionality 462 may create and store snapshots of a requirement object. Snapshot functionality 462 may create and store a snapshot of the requirement object when snapshot functionality 462 is invoked, on a periodic basis (e.g., once every hour), and/or when certain events occur (e.g., a new functionality is added to the requirement object). Snapshot functionality 462 may store the snapshots in versions/change log 422, a revision control system, and/or a configuration management system.

Reporting functionality 464 may create a report based on properties 410, output(s) of applicability functionality 452, output(s) of verifying functionality 454, and/or output(s) of documenting functionality 456 (e.g., over a period of time). For example, reporting functionality 464 may parse an output (e.g., of verifying functionality 454), analyze the parsed output, and create a report that specifies whether a design satisfies a requirement based on the analyzed parsed output. Additionally, or alternatively, the report may be based on properties, output(s) of applicability functionalities, output(s) of verifying functionalities, and/or output(s) of documenting functionalities of one or more other requirement objects (e.g., requirement objects identified in related requirements 420).

Crawling functionality 466 may identify components that satisfy and/or are testable based on the requirement associated with the requirement object based on information stored in description 412, verification rule 414, and/or one or more other properties 410 of requirement structure 400. Crawling functionality 466 may search through one or more repositories to identify one or more candidates (i.e., potential components of the design) that satisfy the requirement and/or are testable based on the requirement. In one example, the one or more repositories may include, for example, one or more databases, one or more online directories, and/or one or more other sources of information about components. In another example, one of the repositories may be distributed across a network. Embodiments may employ web services and/or other techniques for implementing crawling functionality 466.

The repositories may store hardware specifications of components, data sheets of the components, models associated with the components, designs associated with the components, hardware code associated with the components, and/or software code associated with the components. The information, stored in description 412, verification rule 414, and/or one or more other properties 410 of requirement structure 400, may include characteristics that are required and characteristics that are preferred. Crawling functionality 466 may classify the candidates based on how many/which of the preferred characteristics are included in each one of the candidates. The preferred characteristics may be rated on a given scale (e.g., from 1 to 5, with 5 most preferred).

Additionally, or alternatively, crawling functionality 466 may also identify all designs that a requirement object may test against. The requirement object may test against a design when applicability functionality 452 determines that the requirement object is applicable to the design. Testing against the design may include invoking verifying functionality 454. As an example, assume that verifying functionality 454 may determine whether an angular velocity of a system represented by a design is more than a particular threshold and provide an output. Crawling functionality 466 may identify designs that have angular velocity as a parameter.

One of functionalities 450 of the requirement object may reference a functionality of a different requirement object. When the referenced functionality, of the different requirement object, is modified, the one of functionalities 450 may automatically adjust, for example, to reflect and/or mirror the modified referenced functionality. Conversely, when the one of functionalities 450 is modified, the referenced functionality may also automatically adjust, for example, to reflect and/or mirror the modified one of functionalities 450. In another implementation, one or more of functionalities 450 may reference one or more different functionalities of one or more different requirement objects.

### Example Object-Oriented Structure for Requirements

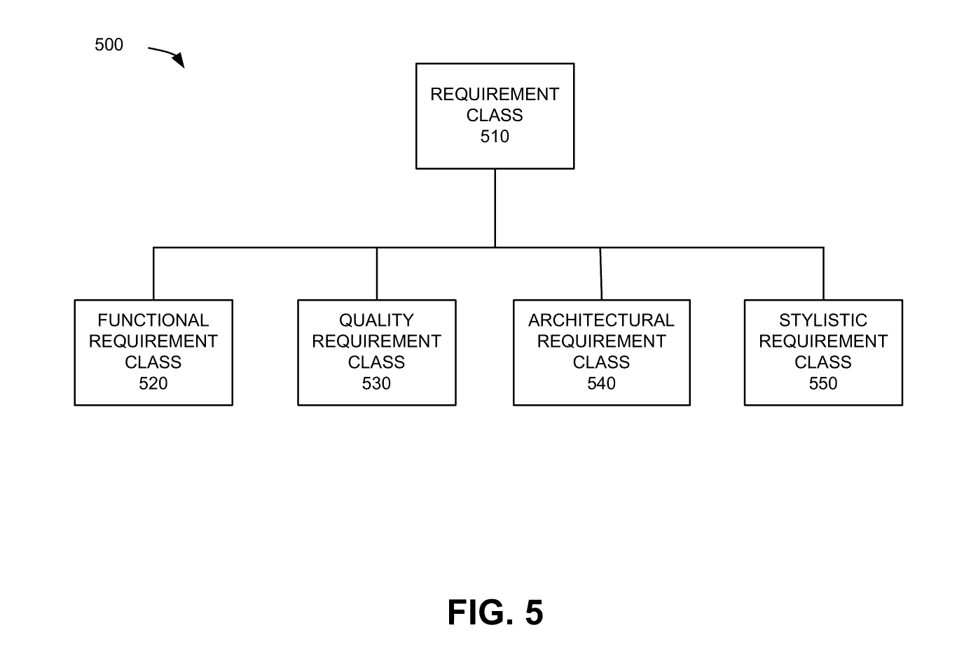

FIG. 5 is a diagram illustrating an example object-oriented architecture 500 for requirements. As shown in FIG. 5, object-oriented architecture 500 (called architecture 500 hereinafter) may include a common concrete or abstract class, labeled requirement class 510, for each of the requirements. Using requirement class 510, architecture 500 may use a single class to control characteristics of one or more functionalities and/or one or more properties of any requirement object that is instantiated for a particular, corresponding, requirement.

In one embodiment, mathematical set notation may be used to create a new class for a requirement element. The new class may be referred to as a subclass of a first class, and the first class may be referred to as a superclass. The use of the mathematical set notation may indicate that the subclass defines a set of class instances that represent a subset of the superset of class instances defined by the superclass. Set notation may be used to create a new subclass from a single class or to indicate that a derived class multiply inherits from two or more base classes.

In another embodiment, an inheritance model may be provided based on sets that defines multiple inheritances such that if a class C inherits from classes A and B, then class C defines a subset of the union of class A and class B. In yet another embodiment, class C may define a subset that is an intersection of class A and class B. While a class may define a set of objects (or potential objects) with certain common attributes, such as functionality and property names, a subclass may define a subset of objects sharing some additional attributes, such as additional property names.

A user may use requirement class 510 to define one or more abstract classes. In an example implementation, as shown in FIG. 5, the user may define a functional requirement class 520, a quality requirement class 530, an architectural requirement class 540, and a stylistic requirement class 550. Each one of functional requirement class 520, quality requirement class 530, architectural requirement class 540, and stylistic requirement class 550 may inherit functionalities, properties, and/or structure of requirement class 510.

Each one of functional requirement class 520, quality requirement class 530, architectural requirement class 540, and/or stylistic requirement class 550 may include additional functionalities and/or properties that are not defined in requirement class 510. For example, functional requirement class 520 may include a verifying functionality that is capable of determining whether a design satisfies a functional requirement.

Each one of functional requirement class 520, quality requirement class 530, architectural requirement class 540, and/or stylistic requirement class 550 may also include customized functionalities that overload functionalities of requirement class 510. For example, requirement class 510 may include a documenting functionality. Architectural requirement class 540 may include a customized documenting functionality that is designed to be invoked for a requirement object that is an instance of the architectural requirement class, instead of the documenting functionality of requirement class 510.

After additional (e.g., customized) functionalities and/or properties are added, each one of functional requirement class 520, quality requirement class 530, architectural requirement class 540, and/or stylistic requirement class 550 may provide a structure that satisfies criteria included in functional requirements information 310, quality requirements information 320, architectural requirements information 330, or stylistic requirements information 340, respectively.

The user may use one of functional requirement class 520, quality requirement class 530, architectural requirement class 540, or stylistic requirement class 550 to define an individual requirement subclass for a particular requirement based on a type of the particular requirement. The individual requirement subclass may inherit functionalities, properties, and/or structure of the parent class (i.e., one of functional requirement class 520, quality requirement class 530, architectural requirement class 540, or stylistic requirement class 550) that is used to create the individual requirement subclass. For example, a user may use functional requirement class 520 to create an individual requirement class corresponding to a functional requirement (e.g., a horizontal motor of a carriage must provide 15 Newton (N) units of force). The individual requirement class may inherit functionalities and/or properties that are defined in requirement class 510 and in functional requirement class 520.

The individual requirement class may also include additional functionalities and/or properties and/or functionalities that overload functionalities of the parent class. For example, the user may define a verification rule for determining whether the horizontal motor of the carriage provides 15 N. The user may add the verification rule as a new property of the individual requirement class. The user may also define a verifying functionality, for the individual requirements class, that uses the verification rule to determine whether the horizontal motor of the carriage provides 15 N and provides an output based on the determination. The verifying functionality may overload an existing verifying functionality of functional requirement class 520. The user and/or requirements framework 200 may instantiate a requirement object based on the individual requirement class. The user and/or requirements framework 200 may invoke a verifying functionality of the instantiated requirement object. The verifying functionality may be defined only for/in the individual requirements class.

### Example Relationships Between Requirements and Components of a Design

FIGS. 6A-6D illustrate example relationships between requirements and components of a design. As shown in FIG. 6A, a design 600 may represent a system. A design may include one or more components. The design may represent relationships between the components. For example, a first component of the design may depend on a second component of the design. The relationship between the first component and the second component may indicate, for example, that the second component includes the first component, that the second component is connected to the first component, that the second component is attached to the first component, that the second component reads data that is written by the first component, etc.

As further shown in FIG. 6A, the system may include the following components: a slider, a controller 610, a carriage, a nozzle, a carriage motor, cameras, a nozzle motor, and one or more components of the controller (shown in FIG. 6B or FIG. 6C). The slider and the controller may depend on the system. Accordingly, the system may include the slider and the controller. The carriage and the nozzle may depend on the slider. Accordingly, the slider may include the carriage and the nozzle. The carriage motor and the cameras may depend on the carriage. Accordingly, the carriage may include the carriage motor and the cameras. The nozzle motor may depend on the nozzle. Accordingly, the nozzle may include the nozzle motor or the motor may be attached to the nozzle to move the nozzle.

As also shown in FIG. 6A, requirements may be associated with individual components of design 600. For example, the slider component may move in a horizontal direction. A first requirement may indicate that for the slider to move fast enough in horizontal direction, the slider should weigh less than 500 grams. The first requirement may be associated with the slider.

A second requirement may indicate that the carriage should weigh less than 100 grams. The second requirement may be associated with the carriage. A third requirement may indicate that the carriage should provide horizontal motion (to the slider). The third requirement may also be associated with the carriage. A fourth requirement may indicate that the carriage motor should provide 15 N. The fourth requirement may be associated with the carriage motor, of the carriage.

A fifth requirement may indicate that the cameras should capture images with 200×400 pixels. The fifth requirement may be associated with the cameras. A sixth requirement may indicate that each of the cameras should weigh less than 75 grams. The sixth requirement may also be associated with the cameras. A seventh requirement may indicate that the nozzle should move in a vertical direction. The seventh requirement may be associated with the nozzle. An eighth requirement may indicate that the nozzle motor should provide 10 N. The eighth requirement may be associated with the nozzle motor, of the nozzle.

A user may create a different individual requirement object for each one of the aforementioned requirements. An individual requirement object may determine whether related component(s) of the system comply with a requirement corresponding to the individual requirement object. As discussed above, one or more individual requirement objects may be grouped into a collection of requirement objects.

As shown in FIG. 6B, controller 610 may include the following components: a horizontal position control, a vertical position control, a coarse control of the horizontal position control, and a fine control of the horizontal position control. The coarse control and the fine control may depend on the horizontal position control. Accordingly, the horizontal position control may include the coarse control and the fine control. A ninth requirement may indicate that the fine control should have an accuracy of ±5 mm. The ninth requirement may be associated with the fine control. The coarse control may not be associated with any requirements.

As described above, design framework component 220 (FIG. 2) may eliminate the coarse control (see FIG. 6C) from design 600 because there are no requirements related to the coarse control. As a result, no specific coarse control may be used in the horizontal position control of the system. Furthermore, since only the fine control is dependent on the horizontal position control, the ninth requirement is equally applicable to a functioning of the horizontal position control. Therefore, design framework component 220 may shift the ninth requirement up one higher hierarchical level (see FIG. 6C) of design 600 to be associated with the horizontal position control. Thereafter, design framework component 220 may also eliminate the fine control (see FIG. 6C) from design 600 because there are no requirements that are specifically related to a functioning of the fine control component.

In another example, the coarse control may be associated with one or more requirements (e.g., a requirement that the coarse control component should achieve positioning with an accuracy of ±100 mm in less than 500 ms). The coarse control may be eliminated, for example, in order to simplify the architecture of the system. Requirements framework 200 may then associate the requirements, which were associated with the coarse control, to a parent component of the coarse control (i.e., the horizontal position control). Requirements framework 200 may modify the properties and/or functionalities of requirement objects corresponding to the requirements in order to associate the requirements with the horizontal position control. For example, requirements framework 200 may modify related components 418 property, of the requirement objects, to identify a “horizontal_position_control” design component instead of a “coarse_control” design component.

As further shown in FIGS. 6B and 6C, vertical position control may include/be associated with a placement property. The vertical position control may satisfy one or more requirements that may be based on the placement property. Furthermore, a requirement may depend on one or more other requirements. In this instance, a design may satisfy the requirement only when the design also satisfies the one or more other requirements.

For example, a tenth requirement may indicate that the vertical position control should reliably attach a block to a board. The tenth requirement may only be satisfied when the design satisfies an eleventh requirement and a twelfth requirement. The tenth requirement may be associated with the vertical position control. The design may satisfy the eleventh requirement when the placement property, associated with the vertical position control, indicates that the block is placed with less than a particular acceleration. The design may satisfy the twelfth requirement when the placement property, associated with the vertical position control, indicates that the block is held in place for at least a particular period of time. The twelfth requirement, like other requirements, may be stored in a block diagram, as described below with reference to FIG. 6D.

FIG. 6D illustrates an example behavioral diagram 620 for a graphical representation of a requirement. The requirement may be used to determine whether an acceleration of a component, of a design, stays low enough (e.g., for a block to be held in place) for a particular period of time. As shown in FIG. 6D, behavioral diagram 620 may receive a time (t) input and an acceleration (a) input (of the component). Based on behavioral diagram 620, requirements framework 200 may take an absolute value (|u|) of the acceleration input, and may determine whether the acceleration input is less than a particular amount (e.g., 0.75).

Requirements framework 200 may use a latch block 625 to hold a last time of when the acceleration was equal to or greater than the particular amount. Requirements framework 200 may use comparison block 630 compare a current time with the last time. In this way, requirements framework 200 may calculate a duration of time for which the acceleration has been less than the particular amount. Requirements framework 200 may determine whether the duration of time is greater or equal to a particular period of time (e.g., 0.0065). Requirements framework may output a positive result, for a property 635 that represents the requirement for the component of the design, when the duration of time is greater or equal to the particular period of time.

### Example Processes

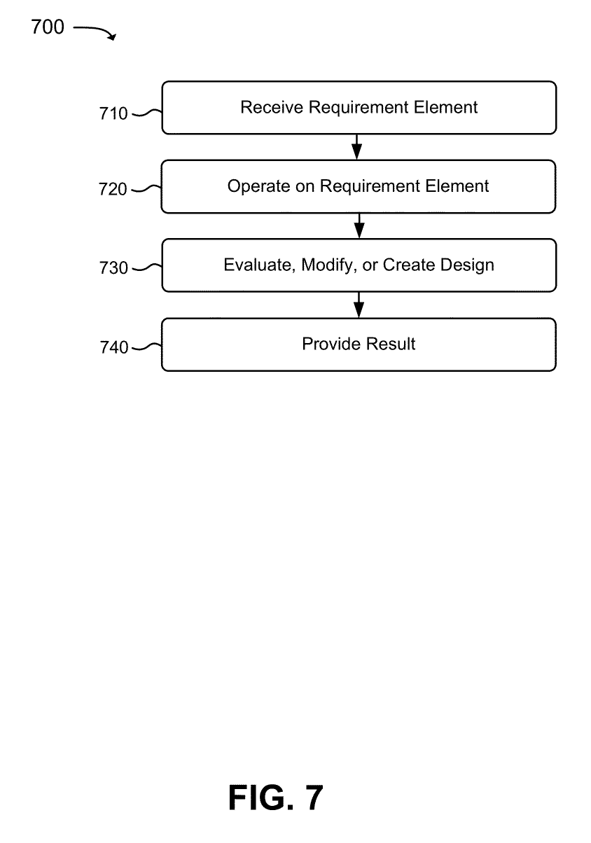

FIG. 7 is a flowchart of an example process 700 for using a requirements framework to evaluate, modify, or create a design. The requirements framework may, for example, correspond to requirements framework 200, of FIG. 2, or a portion of requirements framework 200. Device 100 may perform process 700.

As shown in FIG. 7, process 700 may include receiving a requirement element (block 710). For example, a user may use device 100 to open a user interface that allows the user to access a requirements framework. The user may specify, via the user interface, a location where a requirement element is stored. The requirements framework may receive (e.g., retrieve) information for the requirement element from the location. The requirement element may represent a requirement for a design. The requirement element may include one or more properties and/or one or more functionalities, as described above with reference to FIG. 4. The requirement element may include, for example, a rule property, a verifying functionality, a modifying functionality, a crawling functionality, and/or a reporting functionality. The rule property may specify a rule associated with the requirement.

Process 700 may further include operating on the requirement element (block 720). For example, as described above with reference to FIGS. 2 and 3, the requirements framework may include and/or have access to criteria for requirement elements. Device 100 may operate on the received requirement element based on the criteria. Operating on the requirement element may include modifying the requirement element by, for example, adding/subtracting a different functionality and/or a different property to/from the requirement element.

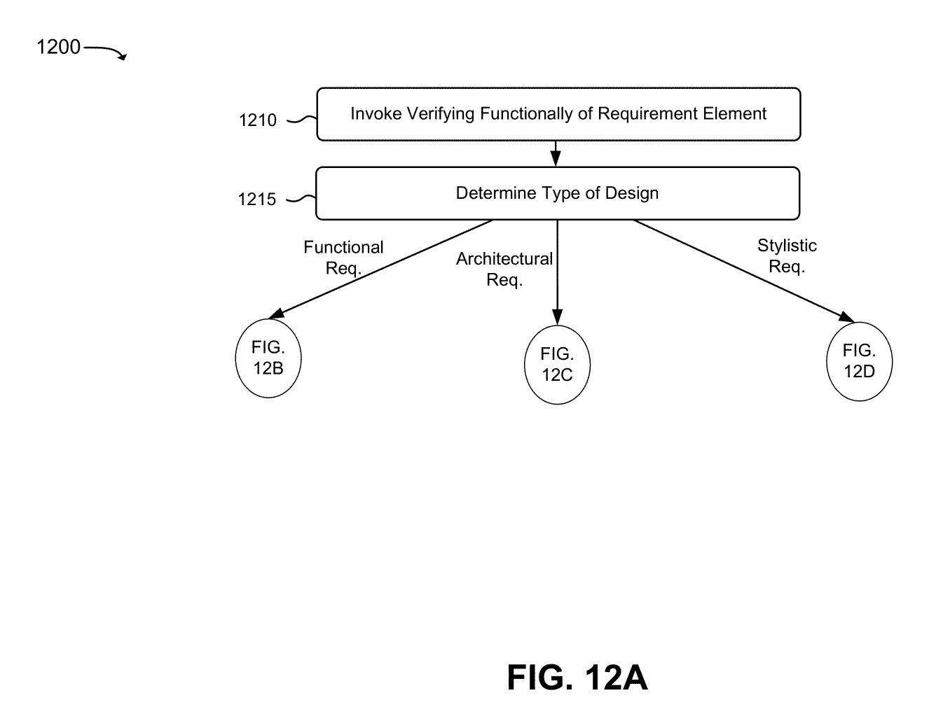

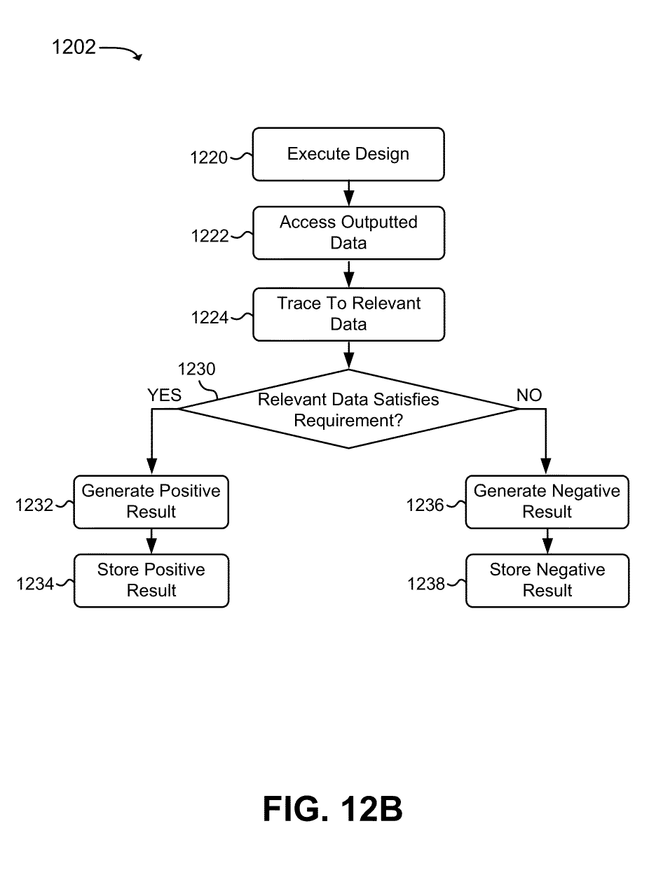

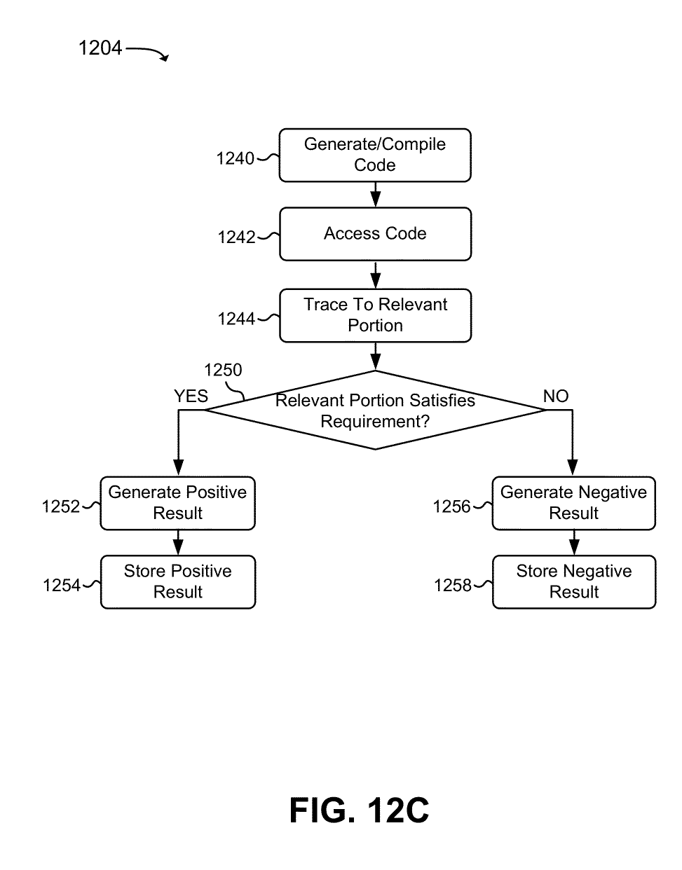

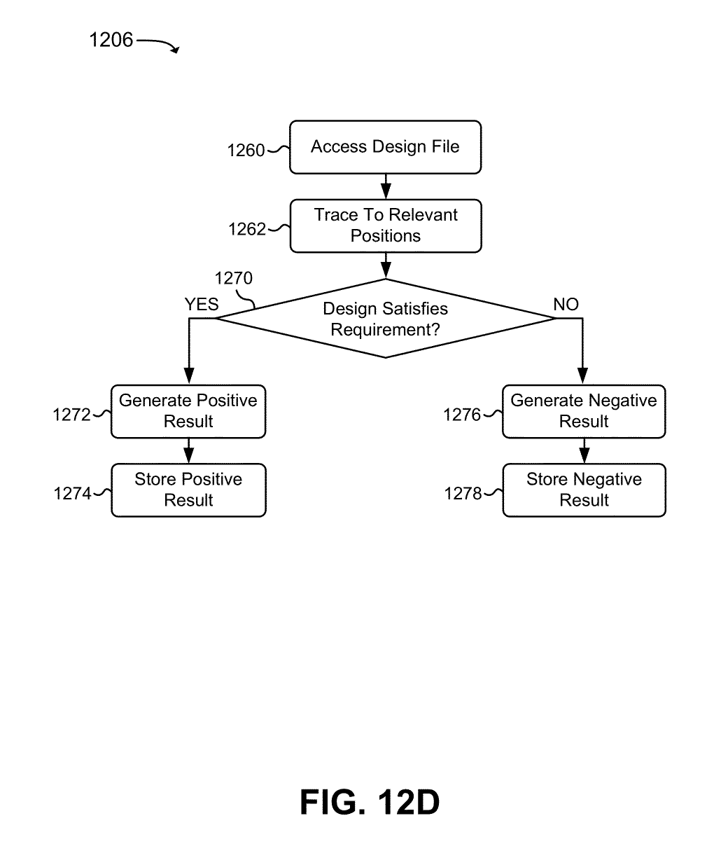

Process 700 may also include evaluating, modifying, or creating a design (block 730). For example, the user may use device 100 to select the requirement element to evaluate, modify, or create a design. To evaluate the design, device 100 may invoke the verifying functionality of the received requirement element. The verifying functionality may determine whether a design satisfies the requirement based on the rule, as described below with reference to FIGS. 12A-12D.

In one implementation, to modify the design, device 100 may invoke the modifying functionality of the received requirement element. The modifying functionality may modify an existing design (e.g., a component of the existing design) in order for the existing design to satisfy the rule. In another implementation, to modify the design, device 100 may invoke the crawling functionality of the received requirement element. The crawling functionality may identify a component that satisfies the rule. Device 100 may add the identified component to an existing design or replace one or more existing components of the existing design with the identified component.

To create the design, device 100 may similarly invoke the crawling functionality. In one implementation, the crawling functionality may identify a design that satisfies the rule. In another implementation, the crawling functionality may identify one or more components that satisfy the rule. Device 100 may use one or more of the one or more identified components to create a new design.

Process 700 may also include providing a result (block 740). In one example, after the user selects to evaluate the existing design and device 100 invokes the verifying functionality, device 100 may invoke the reporting functionality of the requirement element. The reporting functionality may, for example, parse an output of the verifying functionality, analyze the parsed output, and create a report that specifies whether the design satisfies the requirement. The report may specify, for example, a positive result (e.g., “The System Design satisfies the Carriage Weight requirement”) or a negative result (e.g., “The System Design does not satisfy the Carriage Weight requirement”).

In another example, after the user selects to modify the existing design and device 100 modifies the existing design, device 100 may display a representation of the modified, existing design in the user interface associated with the requirements framework. In yet another example, after the user selects to create a new design and device 100 creates the new design, device 100 may display a representation of the new design in the user interface associated with the requirements framework.

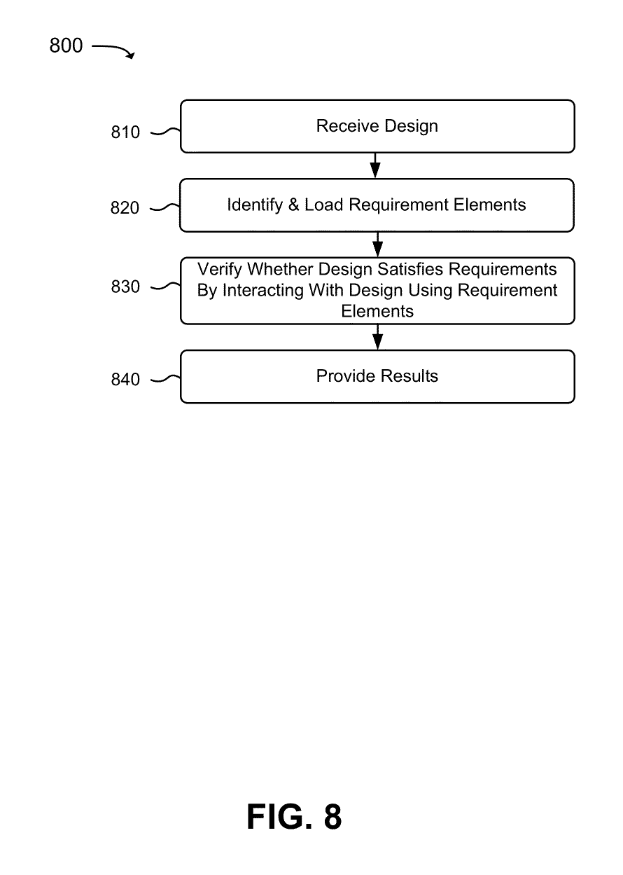

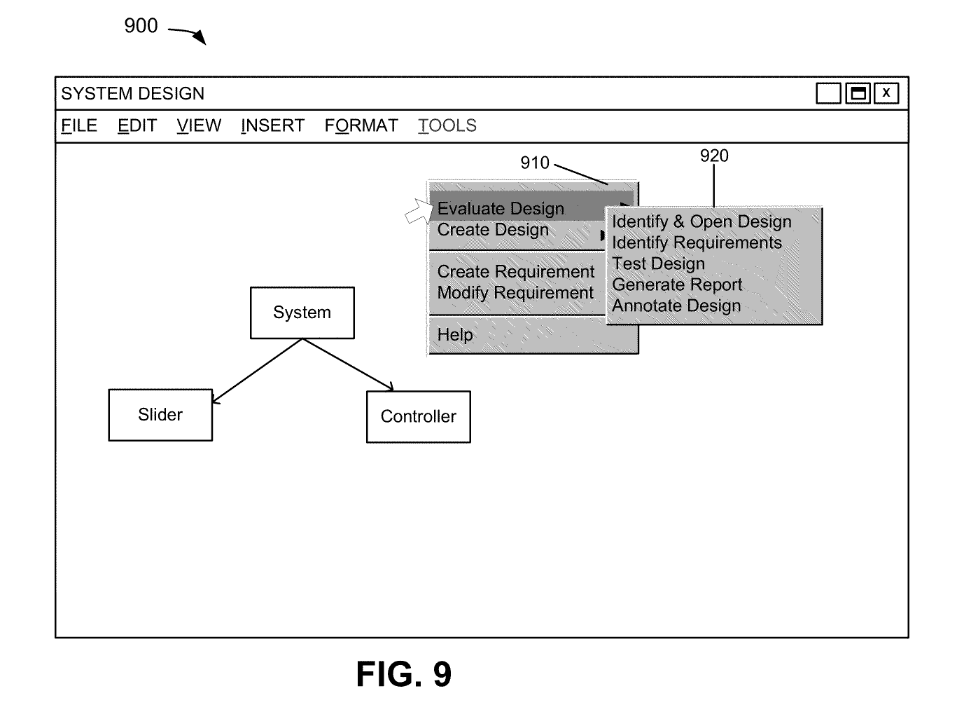

FIG. 8 is a flowchart of an example process 800 for evaluating a design. Process 800 may correspond to blocks 730 and 740 of FIG. 7. A portion of process 800 is described below with reference to FIG. 9. Device 100 may perform process 800.

As shown in FIG. 8, process 800 may include receiving a design (block 810). For example, a user may use device 100 to open a user interface, such as a user interface 900 (FIG. 9). The user may use user interface 900 to create or to retrieve a design of a system. As shown in FIG. 9, user interface 900 may include, for example, a menu 910 that allows the user to create a design. Menu 910 may be displayed in response to selection of an item (e.g., TOOLS) from the toolbar of user interface 900 or may be displayed in response to further events. As further shown in FIG. 9, menu 910 may further allow the user to use the requirements framework to evaluate a design. When the user selects the Evaluate Design menu item, user interface 900 may display an evaluate design sub-menu 920.

Evaluate design sub-menu 920 may include menu items that allow the user to use the requirements framework to evaluate the design. For example, evaluate design sub-menu 920 may include an Identify & Open Design menu item, an Identify Requirements menu item, a Test Design menu item, a Generate Report menu item, and an Annotate Design menu item. When the user selects the Identify & Open Design menu item, device 100 may identify a design and display a representation of the design in user interface 900. When the user selects the Identify Requirements menu item, device 100 may identify one or more requirement elements that represent one or more corresponding requirements. When the user selects the Test Design menu item, device 100 may use the identified requirement elements to determine whether the design satisfies the requirements. When the user selects the Generate Report menu item, device 100 may generate one or more reports that indicate whether the design satisfies one or more of the requirements that are found to be relevant (e.g., by being active or in scope). When the user selects the Annotate Design menu item, device 100 may annotate the representation of the design to indicate whether the design satisfies one or more of the requirements.

For example, the user may select the Identify & Open Design menu item of evaluate design sub-menu 920. Upon selection, user interface 900 may allow the user to select a design and/or a location from where the design may be retrieved. Selecting the location may include selecting a file that includes the design. Device 100 may retrieve the design from the file at the location. As further shown in FIG. 9, user interface 900 may display a representation of the design. The example design, shown in user interface 900, includes two components: a slider and a controller.

Process 800 may further include identifying and loading requirement elements (block 820). For example, the user may select the Identify Requirements menu item of evaluate design sub-menu 920 (FIG. 9). Upon selection, user interface 900 may allow the user to select one or more requirements and/or to identify locations of requirement elements associated with the requirements. Device 100 may identify the requirement elements based on the selected requirements and/or load the requirement elements from the storage/access locations.

Process 800 may also include verifying whether the design satisfies requirements by interacting with the design using the requirement elements (block 830) and providing results (block 840). For example, the user may select the Test Design menu item, of evaluate design sub-menu 920 (FIG. 9), to test the design based on the loaded requirement elements. In one implementation, device 100 may, first, invoke an applicability functionality of each one of the requirement elements to determine which ones of the requirement elements are applicable to the design.

Thereafter, device 100 may invoke a verifying functionality of each one of the applicable requirement elements. The invoked verifying functionalities may interact with the design (e.g., execute the design) and/or information associated with the design (e.g., data outputted due to the execution of the design) to determine whether the design satisfies requirements associated with (e.g., represented by) the applicable requirement elements. Each one of the invoked verifying functionalities may provide a positive result or a negative result. A positive result may indicate that the design and/or one or more particular components of the design satisfy a particular one of the requirements. In contrast, a negative result may indicate that the design and/or one or more particular components of the design do not satisfy a particular one of the requirements.

The user may further request that a report be provided or that the representation of the design be annotated based on the provided results. In one example, the user may select the Generate Report menu item of evaluate design sub-menu 920 (FIG. 9). In response, device 100 may invoke reporting functionalities of the applicable requirement elements. The reporting functionalities may generate one or more reports based on the provided results. The one or more reports may indicate whether the design and/or particular components of the design (e.g., the slider) satisfy the requirements associated with the applicable requirement elements.

In another example, the user may select the Annotate Design menu item of evaluate design sub-menu 920 (FIG. 9). In response, device 100 may invoke annotating functionalities of the applicable requirement elements. The annotating functionalities may annotate the representation of the design, based on the provided results, to indicate whether individual components of the design satisfy the requirements associated with the applicable requirement elements. In other embodiments, a command line interface, instead of, or in addition to, a graphical user interface, may be used to evaluate a design.

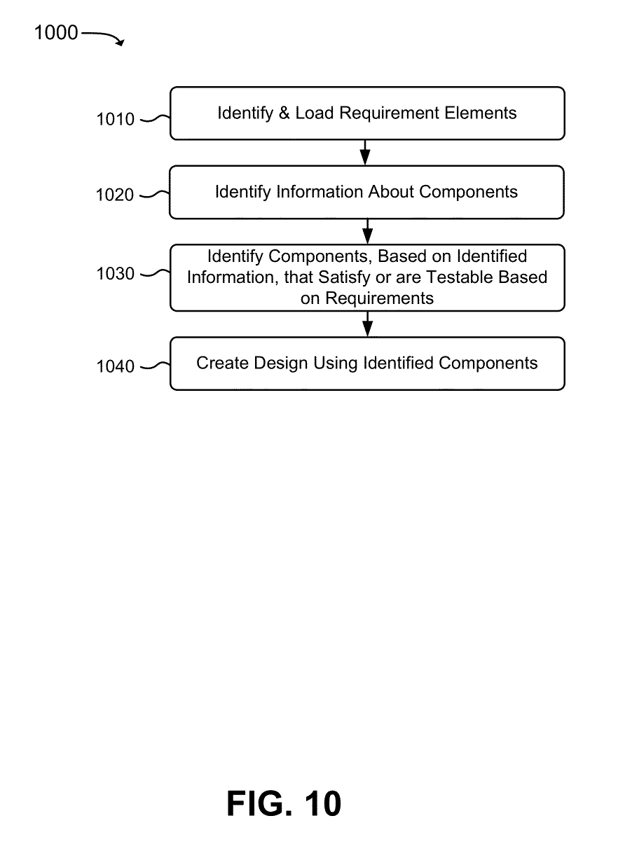

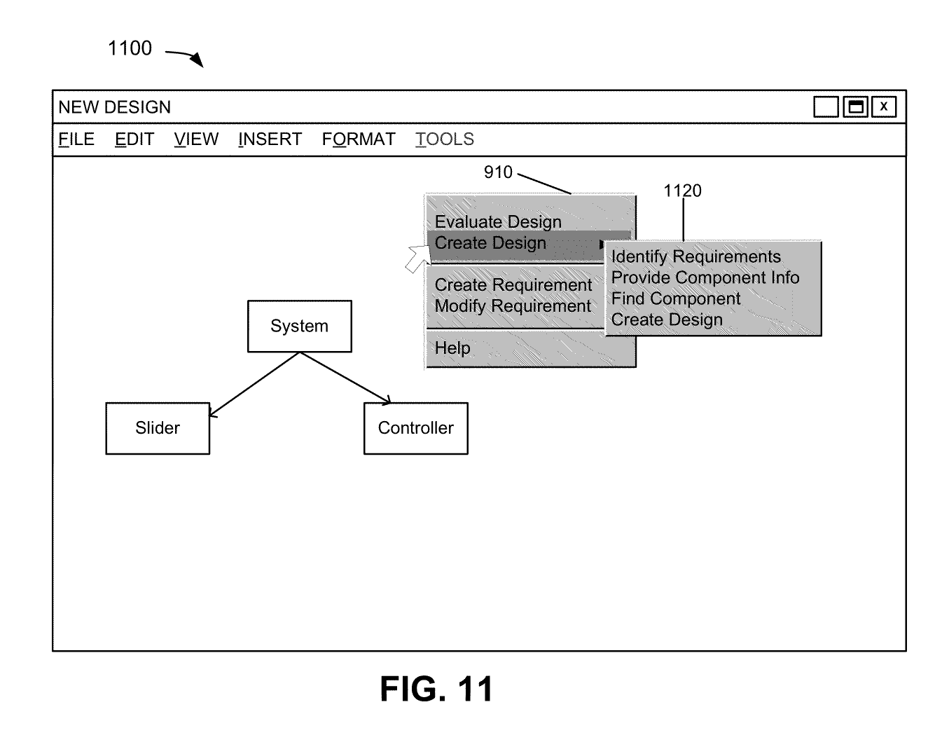

FIG. 10 is a flowchart of an example process 1000 for creating a design. Process 1000 may correspond to blocks 730 and 740 of FIG. 7. A portion of process 1000 is described below with reference to FIG. 11. Device 100 may perform process 1000.

As shown in FIG. 10, process 1000 may include identifying and loading requirement elements (block 1010). For example, a user may use device 1000 to open a user interface 1100 (FIG. 11). As shown in FIG. 11, user interface 1100 may include the same menu bar as user interface 900 (FIG. 9). When the user selects, for example, the TOOLS menu item from the menu bar, user interface 1100 may display tools drop down menu 910.

Tools drop down menu 910 may include a Create Design menu item. When the user selects the Create Design menu item, user interface 1100 may display a create design sub-menu 1120. Create design sub-menu 1120 may include menu items that allow the user to use the requirements framework to create a new design. For example, as shown in FIG. 11, create design sub-menu 1120 may include an Identify Requirements menu item, a Provide Component Info menu item, a Find Component menu item, and a Create Design menu item. When the user selects the Identify Requirements menu item, device 100 may identify one or more requirement elements that represent one or more corresponding requirements. When the user selects the Provide Component Info menu item, device 100 may request and receive, from the user, information about a new design and/or about one or more components of the new design. When the user selects the Find Component menu item, device 100 may find components, based on the information, that satisfy or are testable based on the requirements. When the user selects the Create Design menu item, device 100 may create the new design that includes one or more of the found components.

For example, the user may select the Identify Requirements menu item of create design sub-menu 1120. Upon selection, user interface 1100 may allow the user to select one or more requirements and/or to identify locations of requirement elements associated with the requirements. Device 100 may identify the requirement elements based on the selected requirements and/or load the requirement elements from the storage/access locations.

Process 1000 may further include identifying information about components (block 1020). For example, the user may select the Provide Component Info menu item of create design sub-menu 1120 (FIG. 11). Upon selection, user interface 1100 may allow the user to provide information about a new design and/or about one or more components of the new design. Each one of the one or more components may correspond to one or more of the identified requirement elements. In one example, the user may specify that the new design is a system that includes a slider component and a controller component. In another example, the user may use user interface 1100 to create a representation for the new design by placing one or more blocks on the user interface. The representation may include information about relationships between the components based on the relationships between the blocks. In the example of FIG. 11, the user may have specified the relationship between the system, the slider component, and the controller component.

Process 1000 may also include identifying components, based on the identified information, that satisfy or are testable based on requirements (block 1030). For example, the user may select the Find Component menu item of create design sub-menu 1120 (FIG. 11). In one implementation, after the user selects the Find Component menu item, user interface 1100 may allow the user to specify one or more repositories that store information about different components.

In another implementation, after the user selects the Find Component menu item, device 100 may automatically identify the one or more repositories that store information about different components based on the identified information. For example, the identified information may indicate that the new design includes a component that represents a controller of a mechanical system with a slider. Based on the identified information, device 100 may automatically identify a particular repository (e.g., a particular online database of hardware specifications) that includes information about controller components for mechanical systems with sliders.

Thereafter, device 100 may invoke crawling functionalities of the identified requirement elements. A crawling functionality may search through one or more of the identified repositories to identify one or more candidates based on the identified information. In one implementation, the identified candidates may satisfy a requirement associated with one of the requirement elements that include the crawling functionalities. For example, to identify candidates that satisfy the requirement, a crawling functionality may execute information stored in one of the identified repositories. The crawling functionality may determine that a component, associated with (e.g., defined by) the stored information, satisfies the requirement based on the execution of the stored information.

In another implementation, the identified candidates may be testable based on the requirement associated with one of the requirement elements. A candidate may be testable based on the requirement, when, for example, a verifying functionality may be invoked to determine whether a design that includes the candidate satisfies the requirement. For example, the requirement, for a controller, may require horizontal position control that allows positioning with 5 mm of accuracy. Only controllers with horizontal position controls may be candidates that are testable based on the requirement. The user may use user interface 1110 to identify/select one of the candidates as a component for the new design. In this manner, device 100 may identify all the components of the new design that are specified based on the identified information.

Process 1000 may also include creating a design using the identified components (block 1040). For example, the user may select the Create Design menu item of create design sub-menu 1120 (FIG. 11). In one implementation, after the user selects the Create Design menu item, device 100 may create the new design that includes the identified components based on rules that specify relationships between various components. Thereafter, device 100 may display a representation of the new design in user interface 1100. In another implementation, when the identified information includes a representation provided by the user, device 100 may link the identified components to blocks in the representation that correspond to the identified components. In other embodiments, a command line interface, instead of, or in addition to, a graphical user interface, may be used to create a design.

FIGS. 12A-12D are flowcharts of an example process 1200 for verifying whether a design satisfies a requirement. A portion of process 1200 may correspond to blocks 830 and 840 of FIG. 8. Device 100 may perform process 1200.

Process 1200 may include invoking a verifying functionality of a requirement element (block 1210). For example, a requirements framework may receive a requirement element and a design. The requirement element may represent a requirement for one or more components of the design. The requirement element may include a verifying functionality and a verification rule. The user may prompt the requirements framework to determine whether the design satisfies the requirement. To do so, the requirements framework may invoke a verifying functionality of the requirement element.

Process 1200 may further include determining a type of a design (block 1215). In one implementation, the verifying functionality may determine a type of the design. In another implementation, the requirements framework may determine the type of the design before invoking the verifying functionality. The requirements framework may invoke the verifying functionality based on the type of the design. In one example, the type of the design may refer to a purpose of the design (e.g., a conceptual design, a high-level design, a functional design, a behavioral design, etc.) and/or a representation of the design (e.g., a class diagram, a UML diagram, a time-based block diagram, a state transition diagram, hardware code, software code, etc.). In another example, the type of the design may be associated with a particular modeling tool or a particular source code language used to create the design. In yet another example, the type of the design may refer to a plurality of the aforementioned types.

Process 1200 may proceed differently based on a type of the requirement represented by the requirement element. When the requirement is a functional requirement, process 1200 may include a process 1202 (FIG. 12B) for determining whether the design satisfies the functional requirement.

As shown in FIG. 12B, process 1202 may include executing the design (block 1220), accessing outputted data (block 1222), and tracing to relevant data (block 1224). For example, the verifying functionality may prompt the execution of the design. The execution of the design may output data to a file that is stored at a particular location. The verifying functionality may include and/or have access to information that indicates that output data is stored at the particular location when the particular type of the design is executed. To access the outputted data, the verifying functionality may identify the particular location of the file based on the determined type of the design. Thereafter, the verifying functionally may access the file and, then, access the outputted data in the file. The verifying functionality may further identify a position (e.g., a beginning of line 12 of the outputted data) of relevant data in the outputted data based on the determined type of the design. Thereafter, the verifying functionality may trace to the relevant data (e.g., a value of “50”) at the identified position.

Process 1202 may further include determining whether the relevant data satisfies the requirement (block 1230). In one example, the verification rule may specify that the requirement is satisfied when a particular output (i.e., the relevant data) satisfies a predefined mathematical relationship in comparison to a predefined value (e.g., 25). The predefined mathematical relationship may require for the particular output to be, for example, greater than the predefined value. In this example, the verification functionality may determine that relevant data satisfies the requirement when the relevant data is greater than the predefined value.

In another example, the verification rule may specify that the requirement is satisfied when a part of the execution occurred within a predefined period of time (e.g., 2 seconds). A value of the relevant data may equal an amount of time when the part of the execution occurred. In this example, the verifying functionality may determine that the relevant data satisfies the requirement when the relevant data is less than the predefined period of time.

If the relevant data satisfies the requirement (block 1230—YES), process 1202 may include generating a positive result (block 1232) and storing the positive result (block 1234). For example, when the relevant data satisfies the requirement, the verifying functionality may generate a positive result that indicates that the design and/or a particular component of the design satisfies the requirement represented by the requirement element. The verifying functionality may store the positive result in a location that may be accessed by a reporting functionality of the requirement element.

If the relevant data does not satisfy the requirement (block 1230—NO), process 1202 may include generating a negative result (block 1236) and storing the negative result (block 1238). For example, when the relevant data does not satisfy the requirement, the verifying functionality may generate a negative result that indicates that the design and/or a particular component of the design does not satisfy the requirement represented by the requirement element. The verifying functionality may store the negative result in the location that may be accessed by the reporting functionality of the requirement element.

Returning to FIG. 12A, when the requirement is an architectural requirement, process 1200 may include a process 1204 (FIG. 12C) for determining whether the design satisfies the architectural requirement.

As shown in FIG. 12C, process 1204 may include generating and/or compiling code (block 1240), accessing the code (block 1242), and tracing to a relevant portion of the code (block 1244). For example, the verifying functionality may prompt generating and/or compiling of code based on the design (e.g., the representation of the design). The verifying functionality may store the code at a particular location. After the code is stored, the verifying functionality may access the code at the particular location. The verifying functionality may identify a location (e.g., lines 10-12 of code, a line with a particular variable, etc.) of a relevant portion of the code based on the type of the design. Thereafter, the verifying functionality may trace to the relevant portion (e.g., a particular equation (e.g., x=a+5) within a line of code).

Process 1204 may further include determining whether the relevant portion satisfies the requirement (block 1250). For example, the verification rule may specify that the requirement is satisfied when one variable (e.g., x) is dependent on another variable (e.g., a). The verifying functionality may determine, based on the verification rule, that relevant portion satisfies the requirement when the one variable is defined in terms of the other variable (e.g., x=a+5).

If the relevant portion satisfies the requirement (block 1250—YES), process 1204 may include generating a positive result (block 1252) and storing the positive result (block 1254). For example, when the relevant portion satisfies the requirement, the verifying functionality may generate and store a positive result as described above with reference to blocks 1232 and 1234 of FIG. 12B.

If the relevant portion does not satisfy the requirement (block 1250—NO), process 1204 may include generating a negative result (block 1256) and storing the negative result (block 1258). For example, when the relevant data does not satisfy the requirement, the verifying functionality may generate and store a negative result as described above with reference to blocks 1236 and 1238 of FIG. 12B.

Returning to FIG. 12A, when the requirement is a stylistic requirement, process 1200 may include a process 1206 (FIG. 12D) for determining whether the design satisfies the stylistic requirement. As shown in FIG. 12D, process 1206 may include accessing a design file (block 1260) and tracing to relevant positions (block 1262). For example, the verifying functionality may access a design file that stores the design. In one example, the design may include, for example, a model that is a representation of a system. The verifying functionality may trace to a relevant portion of the model in the file based on a type of the design. Tracing to the relevant portion of the model may include tracing to one or more relevant positions in the model. In another example, the design may include code that is a representation of software. The verifying functionality may trace to one or more relevant positions (e.g., positions where variables are declared) in the code.

Process 1206 may include determining whether the design satisfies the requirement (block 1270). In one example, the verification rule may specify that the requirement is satisfied when lines of the model do not cross. For example, the relevant positions in the model may include end and/or corner points of all the lines in the model. The verifying functionality may determine relative coordinates of the end and/or corner points. The verifying functionality may determine that the requirement is satisfied when the coordinates indicate that lines in the model do not cross.

In another example, the verification rule may specify that the requirement is satisfied when identifiers of all variables in the code are two characters or longer in length. The relevant positions in the code may include positions where the variables are declared. The verifying functionality may determine that the requirement is satisfied when each one of the identifiers is two characters or longer in length.

If the design satisfies the requirement (block 1270—YES), process 1206 may include generating a positive result (block 1272) and storing the positive result (block 1274). For example, when the design satisfies the requirement, the verifying functionality may generate and store a positive result as described above with reference to blocks 1232 and 1234 of FIG. 12B.

If the design does not satisfy the requirement (block 1270—NO), process 1206 may include generating a negative result (block 1276) and storing the negative result (block 1278). For example, when the design does not satisfy the requirement, the verifying functionality may generate and store a negative result as described above with reference to blocks 1236 and 1238 of FIG. 12B.

### Example Distributed Network

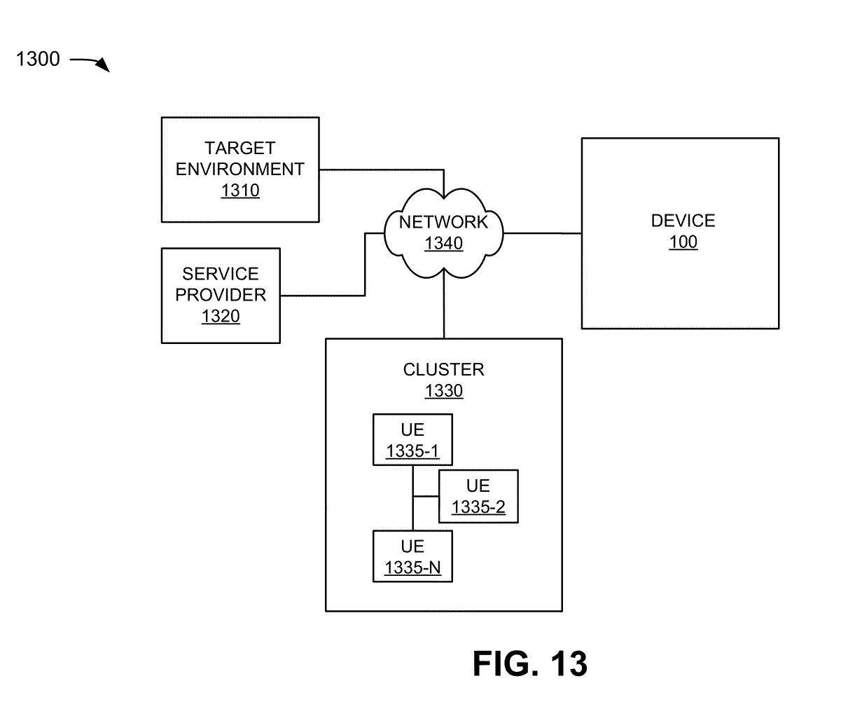

FIG. 13 illustrates an example of a distributed network 1300 in which systems and/or methods described herein may be implemented. Referring to FIG. 13, environment 1300 may contain various entities including device 100, target environment 1310, service provider 1320, cluster 1330, and network 1340. Note that the distributed environment 1300 is just one example of a distributed environment that may be used with embodiments of the invention. Other distributed environments that may be used with embodiments of the invention may contain more entities, fewer entities, entities in arrangements that differ from the arrangement illustrated in FIG. 13, and so on. Moreover, the distributed environments may be configured to implement various “cloud computing” frameworks.

Details of device 100 were described above with respect to FIG. 1. In distributed environment 1300, device 100 may be configured to, among other things, exchange information (e.g., data) with other entities in network 1340 (e.g., target environment 1310, service provider 1320, and cluster 1330). Device 100 may interface with the network 1340 via communication interface 180.

Target environment 1310 may be configured to execute and/or interpret a compiled version of a model which may be generated in or otherwise made available to the distributed environment 1300. The network 1340 may include a communication network capable of exchanging information between the entities in the network 1340. The network 1340 may include digital and/or analog aspects. The information may include machine-readable information having a format that may be adapted for use, for example, in the network 1340 and/or with one or more entities in the network 1340. For example, the information may be encapsulated in one or more packets that may be used to transfer the information through the network 1340.

Information may be exchanged between entities using various network protocols, such as, but not limited to, the Internet Protocol (IP), Asynchronous Transfer Mode (ATM), Synchronous Optical Network (SONET), the User Datagram Protocol (UDP), Transmission Control Protocol (TCP), Institute of Electrical and Electronics Engineers (IEEE) 802.10, 802.11, etc.

Network 1340 may comprise various network devices, such as gateways, routers, switches, firewalls, servers, repeaters, address translators, etc. Portions of network 1340 may be wired (e.g., using wired conductors, optical fibers, etc.) and/or wireless (e.g., using free-space optical (FSO), radio frequency (RF), acoustic transmission paths, etc.). Portions of network 1340 may include a substantially open public network, such as the Internet. Portions of network 1340 may include a more restricted network, such as a private corporate network or virtual private network (VPN). It should be noted that implementations of networks and/or devices operating on networks described herein are not limited with regards to, for example, information carried by the networks, protocols used in the networks, and/or the architecture/configuration of the networks.

Service provider 1320 may include logic that makes a service available to another entity in distributed environment 1300. Service provider 1320 may also include a server operated by, for example, an individual, a corporation, an educational institution, a government agency, and so on, that provides one or more services to a destination, such as device 100. The services may include software containing computer-executable instructions that implement one or more embodiments of the invention or portions thereof, and may be executed, in whole or in part, by (1) a destination, (2) service provider 1320 on behalf of the destination, or (3) some combination thereof.

For example, in an embodiment, service provider 1320 may provide one or more subscription-based services that may be available to various customers. The services may be accessed by a customer via network 1340. The customer may access the services using a computer system, such as device 100. The services may include services that implement one or more embodiments of the invention or portions thereof. Service provider 1320 may limit access to certain services based on, e.g., a customer service agreement between the customer and service provider 1320.

The service agreement may allow the customer to access the services that may allow the customer to build, execute, and/or analyze a model for a design, as described above. The service agreement may include other types of arrangements, such as certain fee-based arrangements or restricted access arrangements. For example, a customer may pay a fee which provides the customer unlimited access to a given package of services for a given time period (e.g., per minute, hourly, daily, monthly, yearly, etc.). For services not included in the package, the customer may have to pay an additional fee in order to access the services. Still other arrangements may be resource-usage based. For example, the customer may be assessed a fee based on an amount of computing resources and/or network bandwidth used.

Cluster 1330 may include a number of units of execution (UEs) 1335 that may perform processing of one or more embodiments of the invention or portions thereof on behalf of device 100 and/or another entity, such as service provider 1320. UEs 1335 may reside on a single device or chip or on multiple devices or chips. For example, UEs 1335 may be implemented in a single ASIC or in multiple ASICs. Likewise, UEs 1335 may be implemented in a single computer system or multiple computer systems. Other examples of UEs 1335 may include FPGAs, CPLDs, ASIPs, processors, multiprocessor systems-on-chip (MPSoCs), graphic processing units, microprocessors, etc. UEs 1335 may be configured to perform operations on behalf of another entity. Service provider 1320 may configure cluster 1330 to provide, for example, the above-described services to computing device 100 on a subscription basis (e.g., via a web service).

### CONCLUSION

A technical computing environment (TCE) may provide an environment that may enable a user to create designs of systems, simulate systems, perform advanced analysis, visualize data, develop algorithms, etc. The TCE may be a graphical-based modeling environment, a textual-based modeling environment, and/or a hybrid modeling environment (e.g., a combination of graphical and textual modeling environments).

The TCE may include hardware and/or software based logic that provides a computing environment that allows operators to perform tasks related to disciplines, such as, but not limited to, mathematics, science, engineering, medicine, business, etc., more efficiently than if the tasks were performed in another type of computing environment, such as an environment that required the operator to develop code in a conventional programming language, such as Java, C++, C, Fortran, Pascal, etc. The TCE may connect a model with code that is executing externally (e.g., on a target processor) to enable a processor-in-the-loop configuration, hardware-in-the-loop configuration, software-in-the-loop configuration, or model-in-the-loop configuration. The executable code may generate variable information that may be stored in a logical workspace and/or presented for display via a user interface associated with the logical workspace.

The TCE may automatically generate code from at least part of a design. The code may be software code (e.g., Java, C, C++, SystemC, etc.), hardware code (e.g., hardware description language (HDL), etc.), or some combination thereof.

Examples of TCEs that may be modified to incorporate one or more embodiments of the invention include, but are not limited to, the MATLAB®, Simulink®, Stateflow®, Simscape™, and SimEvents®, software applications which are available from The MathWorks, Inc., Natick, Mass.; Unified Modeling Language (UML); profiles associated with UML (e.g., Modeling Analysis and Real-Time Embedded Systems (MARTE), Systems Modeling Language (SysML), Avionics Architecture Description Language (AADL)); GNU Octave from the GNU Project; MATRIXx and LabView® from National Instruments; Mathematica from Wolfram Research, Inc.; Mathcad from Mathsoft Engineering & Education Inc.; Maple from Maplesoft; Extend from Imagine That, Inc.; Scilab and Scicos from The French Institution for Research in Computer Science and Control (INRIA); Modelica and Dymola from Dynasim AB; VisSim from Visual Solutions; SoftWIRE from Measurement Computing Corporation; WiT from DALSA Coreco; VEE Pro and SystemVue from Agilent Technologies, Inc.; Vision Program Manager from PPT Vision, Inc.; Khoros from Khoral Research, Inc.; VisiQuest from Pegasus Imaging Corporation; Gedae from Gedae, Inc.; Virtuoso from Cadence Design Systems, Inc.; Rational Rose, Rhapsody, and Tau from International Business Machines (IBM), Inc.; SCADE from Esterel Technologies; the Eclipse development platform from the Eclipse Foundation; MagicDraw from No Magic, Inc.; CoWare from CoWare, Inc.; and Ptolemy from the University of California at Berkeley.

A design may be, for example, a time-based graphical block diagram model, a state transition diagram, a discrete event model, an activity diagram, a UML diagram, a sequence diagram, a data flow model, or some other type of model or diagram. The design may be configured to represent a system, such as a physical system. The design may be graphical, textual, or some combination of graphical and textual. The system represented by the design may be dynamic (e.g., a dynamic system design), linear, non-linear, or some other type of system.

A dynamic system (either natural or man-made) may be a system whose response at any given time may be a function of its input stimuli, its current state, and a current time. Such systems may range from simple to highly complex systems. Natural dynamic systems may include, for example, a falling body, the rotation of the earth, bio-mechanical systems (muscles, joints, etc.), bio-chemical systems (gene expression, protein pathways), weather, and climate pattern systems. Examples of man-made or engineered dynamic systems may include, for example, a bouncing ball, a spring with a mass tied on an end, automobiles, airplanes, control systems in major appliances, communication networks, audio signal processing systems, and a stock market.

The system represented by the design may have various execution semantics that may be represented in model as a collection of modeling elements, often referred to as blocks. A block may generally refer to a portion of functionality that may be used in the design. The block may be graphically represented. However, the block does not necessarily need to be represented graphically. For example, the block may be represented textually or stored in some form of internal representation. Also, a particular visual depiction used to represent the block, for example in a graphical block diagram, may be an arbitrary design choice.

A block may be hierarchical in that the block itself may comprise one or more blocks that make up the block. A block comprising one or more blocks (sub-blocks) may be referred to as a subsystem block. A subsystem block may be configured to represent a subsystem of the overall system represented by the model.

A requirement element may represent a requirement object created by using object-oriented programming techniques and/or a dynamically typed object-oriented programming language. In other embodiments, the requirement element may include one or more other types of data structures that are not object-oriented based.

The foregoing description of implementations provides illustration and description, but is not intended to be exhaustive or to limit the invention to the precise form disclosed. Modifications and variations are possible in light of the above teachings or may be acquired from practice of the invention.

For example, while series of blocks have been described with regard to processes of FIGS. 7, 8, 10, and 12A-12D, the order of the blocks may be modified in other implementations. Further, non-dependent blocks may be performed in parallel.

It will be apparent that example aspects, as described above, may be implemented in many different forms of software, firmware, and hardware in the embodiments illustrated in the figures. The actual software code or specialized control hardware used to implement these aspects should not be construed as limiting. Thus, the operation and behavior of the aspects were described without reference to the specific software code—it being understood that software and control hardware could be designed to implement the aspects based on the description herein.

Further, certain portions, described herein, may be implemented as “logic” that performs one or more functions. This logic may include hardware, such as an application specific integrated circuit or a field programmable gate array, software, or a combination of hardware and software.

Even though particular combinations of features are recited in the claims and/or disclosed in the specification, these combinations are not intended to limit the disclosure of the invention. In fact, many of these features may be combined in ways not specifically recited in the claims and/or disclosed in the specification. Although each dependent claim listed below may directly depend on only one other claim, the disclosure of the invention includes each dependent claim in combination with every other claim in the claim set.

No element, act, or instruction used in the present application should be construed as critical or essential to the invention unless explicitly described as such. Also, as used herein, the article “a” is intended to include one or more items. Where only one item is intended, the term “one” or similar language is used. Further, the phrase “based on” is intended to mean “based, at least in part, on” unless explicitly stated otherwise.

What is claimed is:

1. A method comprising:
instantiating a requirement element, for a requirement, within a requirements framework, the instantiating being performed by a computing device;
identifying a design, the identifying being performed by the computing device;
interacting, by the computer device, with the design using the requirement element, where:
the interacting comprises invoking a functionality of the requirement element,
the functionality initiates the interacting, and
the interacting is performed by the computing device; and
returning, by the computer device, a result, where the result is based on the interacting that identifies whether the design satisfies the requirement, the returning being performed by the computing device.

2. The method of claim 1, where:
the requirements element is an object created by using a dynamically typed object-oriented programming language, and
the requirements framework is an object-based framework.

3. The method of claim 1, where the design comprises one or more of:
a dynamic system design, or
an implementation based on the dynamic system.

4. The method of claim 1, where the design comprises a plurality of execution domains including:
a first execution domain comprising:
a first continuous time domain,
a first discrete time domain,
a first discrete event-based domain,
a first control flow-based domain, or
a first data flow-based domain, and
a second execution domain comprising:
a second continuous time domain,
a second discrete time domain,
a second discrete event-based domain,
a second control flow-based domain, or
a second data flow-based domain.

5. The method of claim 1, where the design comprises one or more of:
a conceptual design,
a high-level design,
a detailed design,
a functional design,
an architectural design,
a structural design, or
a behavioral design.

6. The method of claim 1, where the design comprises one or more of:
a class diagram,
a state transition diagram,
a unified modeling language (UML) diagram,
a system modeling language (SysML) diagram, or
an architecture description language (ADL) diagram.

7. The method of claim 1, where invoking the functionality comprises one of:
a method call,
a remote method invocation,
a procedure call,
a remote procedure call, or
a function call.

8. The method of claim 1, where:
the requirement element further comprises:
an annotating functionality, and
the interacting further comprises:
annotating the design based on the result by invoking the annotating functionality.

9. The method of claim 1, where:
the requirement is a functional requirement associated with a realization of the design, and
the functional requirement is satisfied when:
an output, of the realization of the design, satisfies a predefined mathematical relationship in comparison to a predefined value, or
a part of the execution occurs within a predefined period of time.

10. The method of claim 1, where:
the requirement is a functional requirement associated with an implementation of the design, and
the functional requirement is satisfied when:
an output, of the implementation of the design, satisfies a predefined mathematical relationship in comparison to a predefined value, or
a part of the execution occurs within a predefined period of time.

11. A system comprising:
a memory to store instructions; and
a processor to execute the instructions in the memory to:
receive a design,
receive a requirement object representing a requirement for the design, where the requirement object comprises a first functionality and a second functionality, and
interact with the design by using the requirement object, where, when interacting with the design, the processor is to:
invoke the first functionality to determine whether the design satisfies the requirement, and
invoke the second functionality to provide a result of invoking the first functionality.

12. The system of claim 11, where, when invoking the first functionality, the processor is further to:
determine at least one of a type of the design or a representation of the design,
access stored data based on at least one of the type or the representation, where the stored data comprises an output from an execution of the design,
identify a position of relevant data in the stored data based on at least one of the type or the representation,
trace to the relevant data, and
determine whether the design satisfies the requirement based on the relevant data.

13. The system of claim 12, where, when accessing the stored data, the processor is further to:
identify a file that includes the stored data, and
access the file.

14. The system of claim 11, where the type of the design is associated with a particular modeling tool or a particular source code language used to create the design.

15. One or more non-transitory computer-readable media comprising:
one or more instructions, which when executed by a processor, cause the processor to interact with a requirement element representing a requirement for a design, the requirement element comprising:
information for facilitating the requirements framework, the information comprising at least one of a functionality or a property;
one or more instructions, which when executed by the processor, cause the processor to receive the information using the requirements framework;
one or more instructions, which when executed by the processor, cause the processor to operate on the received information by using the requirements framework; and
one or more instructions, which when executed by the processor, cause the processor to perform actions related to the requirement, where the actions comprise:
evaluating the design,
modifying the design, or
creating the design.

16. The media of claim 15, where the one or more instructions to operate on the received information comprise:
one or more instructions to add a different functionality to the requirements element.

17. The media of claim 16, where the one or more instructions to create the design comprise:
one or more instructions to explore a repository for one or more components that satisfy the requirement or are testable based on the requirement, and
one or more instructions to create the design based on the one or more components.

18. The media of claim 17, where the repository is distributed across a network.

19. The media of claim 17, where the repository stores information associated with one or more of:
hardware specifications,
models,
designs,
hardware code, or
software code.

20. The media of claim 19, where the one or more instructions to explore the repository comprise:
one or more instructions to execute the stored information, and
one or more instructions to determine whether the one or more components satisfy the requirement based on the execution of the stored information.

21. The media of claim 15, where:
the functionality is a verifying functionality,
the information of the requirement element further comprises a reporting functionality, and
the one or more instructions to evaluate the design comprise:
one or more instructions to verify whether the design satisfies the requirement by invoking the verifying functionality, and
one or more instructions to document a result of verifying whether the design satisfies the requirement by invoking the reporting functionality.

22. The media of claim 21, where:
the one or more instructions to verify whether the design satisfies the requirement comprise:
one or more instructions to determine a type of the design, and
one or more instructions to invoke the verifying functionality based on the type, and
the verifying functionality provides the result.

23. The media of claim 22, where:
the property comprises a rule associated with the requirement, and
when the requirement is a functional requirement, the one or more instructions to invoke the verifying functionality comprise:
one or more instructions to access stored data, where the stored data comprises an output from an execution of the design,
one or more instructions to trace to a position of relevant data, of the stored data, based on the type, where the position is specified by the requirement element,
one or more instructions to determine whether the relevant data satisfies the rule, and
one or more instructions to generate a positive result, for the result, when the relevant data satisfies the rule.

24. The media of claim 22, where:
the requirement element comprises a rule associated with the requirement, and
the one or more instructions to invoke the verifying functionality comprise:
one or more instructions to access code generated based on the design,
one or more instructions to trace to a relevant portion of the code, where a location of the relevant portion is specified by the requirement element,
one or more instructions to determine whether the relevant portion satisfies the rule, and
one or more instructions to generate a positive result, for the result, when the relevant portion satisfies the rule.

25. The media of claim 24, where the requirement is an architectural requirement.

26. The media of claim 22, where:
the requirement element comprises a rule associated with the requirement, and
when the requirement is a stylistic requirement, the one or more instructions to invoke the verifying functionality comprise:
one or more instructions to access a model associated with the design,
one or more instructions to trace to a relevant portion of the model, where the relevant portion is specified by the requirement element,
one or more instructions to determine whether the relevant portion satisfies the rule, and
one or more instructions to generate a positive result, for the result, when the relevant portion satisfies the rule.

27. A system comprising:
a memory to store instructions and a requirements framework; and
a processor to execute the instructions in the memory to:
receive a requirement object representing a requirement for a component of a design, where the requirement object comprises a first functionality,
receive information about the component,
identify the component, based on the identified information, that satisfies the requirement by invoking the first functionality, and
create or modify the design based on the identified component.

28. The system of claim 27,
where, when identifying the component, the processor is further to:
explore a repository for the component, and
where the repository stores information associated with one or more of:
hardware specifications,
models,
designs,
hardware code, or
software code.

29. The system of claim 28, where, when exploring the repository, the processor is further to:
execute the stored information, and
determine that the component satisfies the requirement based on the execution of the stored information.

30. The method of claim 27, where the design comprises one or more of:
hardware code, or
software code.
